(19) United States
(12) Patent Application Publication
(10) Pub. No.: US 2026/0187722 A1
(43) Pub. Date: Jul. 2, 2026

(54) USER INTERFACES OF A MOBILE APPLICATION FOR A CUSTODIAL TOKEN PLATFORM

(71) Applicant: Coinbase, Inc., Oakland, CA (US)

(72) Inventors: Thana-On Punkasem, Issaquah, WA (US); Reed Williams, New York City, NY (US); Ayush Rastogi, Secaucus, NJ (US)

(21) Appl. No.: 19/005,830

(22) Filed: Dec. 30, 2024

(51) Int. Cl. G06Q 40/04; G06F 9/451

(52) U.S. Cl. CPC G06Q 40/04; G06F 9/451

(57) ABSTRACT

A mobile application may display user interface pages for accessing a custodial token platform. A described method may include displaying a first user interface page of the mobile application, the first user interface page associated with exchange of a first crypto token and including a set of fields associated with an exchange order for the first crypto token and a dynamically updated order book. The method may further include displaying, in response to detecting a first user input, an orders section within the first user interface page and including one or more first open exchange orders associated with the first crypto token and a user interface button associated with viewing open exchange orders. The method may further include displaying, in response to receiving a second user input, a second user interface page of the mobile application, the second user interface page comprising open exchange orders for multiple crypto tokens.

The present disclosure relates generally to data management, including techniques for user interfaces of a mobile application for a custodial token platform.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports user interfaces of a mobile application for a custodial token platform in accordance with aspects of the present disclosure.

FIG. 2 shows an example of a user interface of a mobile application for a custodial token platform in accordance with aspects of the present disclosure.

FIG. 3 shows an example of a user interface of a mobile application for a custodial token platform in accordance with aspects of the present disclosure.

FIG. 4 shows an example of a user interface of a mobile application for a custodial token platform in accordance with aspects of the present disclosure.

FIG. 5 shows an example of a user interface of a mobile application for a custodial token platform in accordance with aspects of the present disclosure.

FIG. 6 shows an example of a user interface of a mobile application for a custodial token platform in accordance with aspects of the present disclosure.

FIG. 7 shows an example of a user interface of a mobile application for a custodial token platform in accordance with aspects of the present disclosure.

FIG. 8 shows an example of a user interface of a mobile application for a custodial token platform in accordance with aspects of the present disclosure.

FIG. 9 shows an example of a user interface of a mobile application for a custodial token platform in accordance with aspects of the present disclosure.

FIG. 10 shows an example of a user interface flow of a mobile application for a custodial token platform in accordance with aspects of the present disclosure.

FIG. 11 shows a block diagram of an apparatus that supports user interfaces of a mobile application for a custodial token platform in accordance with aspects of the present disclosure.

FIG. 12 shows a block diagram of a client application that supports user interfaces of a mobile application for a custodial token platform in accordance with aspects of the present disclosure.

FIG. 13 shows a diagram of a system including a device that supports user interfaces of a mobile application for a custodial token platform in accordance with aspects of the present disclosure.

FIGS. 14 through 17 show flowcharts illustrating methods that support user interfaces of a mobile application for a custodial token platform in accordance with aspects of the present disclosure.

### DETAILED DESCRIPTION

A custodial token platform may be accessed by users to buy, sell, stake, and/or exchange digital assets, such as cryptocurrency, crypto tokens, and the like. Additionally, the custodial token platform may offer advanced trading options, interfaces, components, and metrics such as candlestick charts, depth charts (e.g., order books), trading volume metrics, and other advanced trading functionality. Advanced traders may use these interfaces and metrics to trade digital assets across different markets, including spot markets and derivative markets (e.g., perpetual futures markets and futures markets). Due to the complexity of such platforms, these platforms may be generally accessed using desktop and or laptop displays. That is, because of the display space typically used to display the various user interfaces for a trading platform (e.g., charts, orderbooks, and metrics), the trading platforms are accessed via desktop or laptop displays, and mobile devices (e.g., smartphones) may not be adept at displaying the various options and interfaces associated with advanced trading. Additionally, if these options and interfaces are displayed on mobile devices, the platform may not be user friendly and may be subject to errors and lag.

Techniques described herein support a user friendly advanced trading application for mobile devices. The mobile application may include various user interface pages that support advanced trading techniques for multiple digital assets (e.g., crypto tokens). For example, the mobile application may include a set of tabs for navigation between spot markets, derivative markets, open orders, among other options. Additionally, information about each crypto token or trading pair (e.g., crypto token and second crypto token, such as a stablecoin) may be accessed via a user interface page, which may be referred to as an asset detail page. The asset detail page may include a dynamically updated chart (e.g., candlestick chart) with options for chart navigation and modification (e.g., adjusting interval and adding indicators). Additionally, the asset detail page may include a depth chart (e.g., order book) and options to navigate to a corresponding trade page (e.g., another user interface page). The trade page may include fields for entering information for placing different types of orders and may include a toggleable dynamically updated order book, dynamically updated in-line chart (e.g., a candlestick chart), and an open orders section. A user may also navigate to another page, referred to as an open orders page, which includes information about open orders for multiple different crypto tokens. Moreover, the mobile application may support various techniques for navigation to asset detail pages and trade pages for multiple crypto tokens.

Thus, the mobile application described herein supports various user friendly user interfaces for advanced trading. Users may be able to view various user interfaces, such as charts and metrics, to analyze trading behaviors and place advanced trades via a mobile display. Moreover, as described in further detail herein, the dynamically updated information may be obtained in a manner that reduces lag and errors, and limits mobile device resource overhead, such as memory and power resource overhead. These and other techniques are described in further detail with respect to the figures.

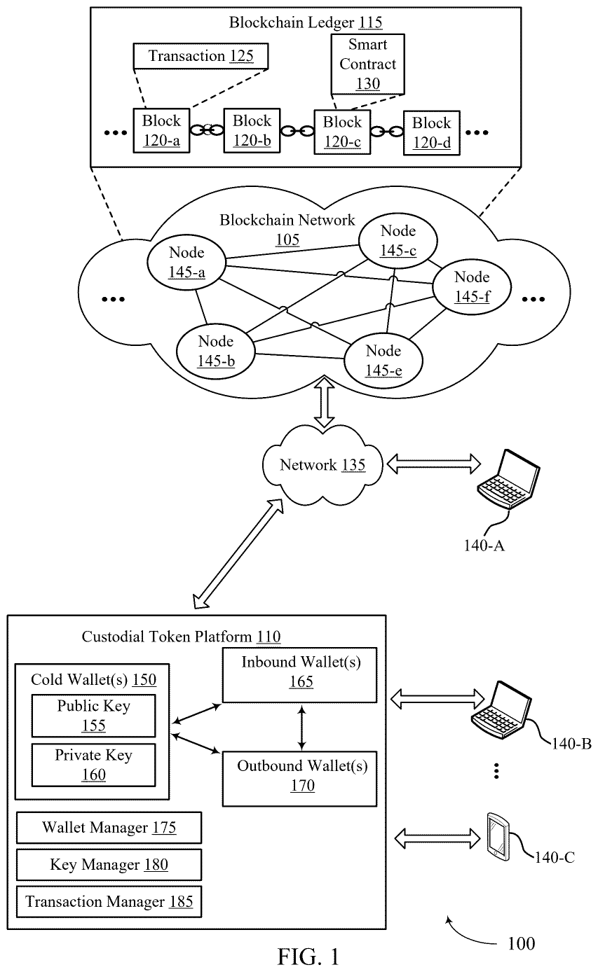

FIG. 1 illustrates an example of a computing environment 100 of a mobile application for a custodial token platform in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

As described herein, the custodial token platform 110 may be accessed via various computing devices 140, such as the computing device 140-b (e.g., a laptop) and the computing device 140-c (e.g., mobile device). In some cases, the user may access the custodial token platform 110 via the computing device 140-b by accessing a website associated with the custodial token platform. The website for the custodial token platform 110 may display various advanced trading components, such as charts, order books, metrics, etc. Additionally, as described herein, the user may access the custodial token platform 110 from the computing device 140-c via an mobile application on the computing device 140-c. The user interfaces supported by the mobile application may also include various user interface pages that include various user interface components for advanced trading, such as charts, order books, metrics, etc. Additionally, the mobile application may support seamless and user friendly user navigation between these various user interface pages. The mobile application may thus display information to support placing advanced trades.

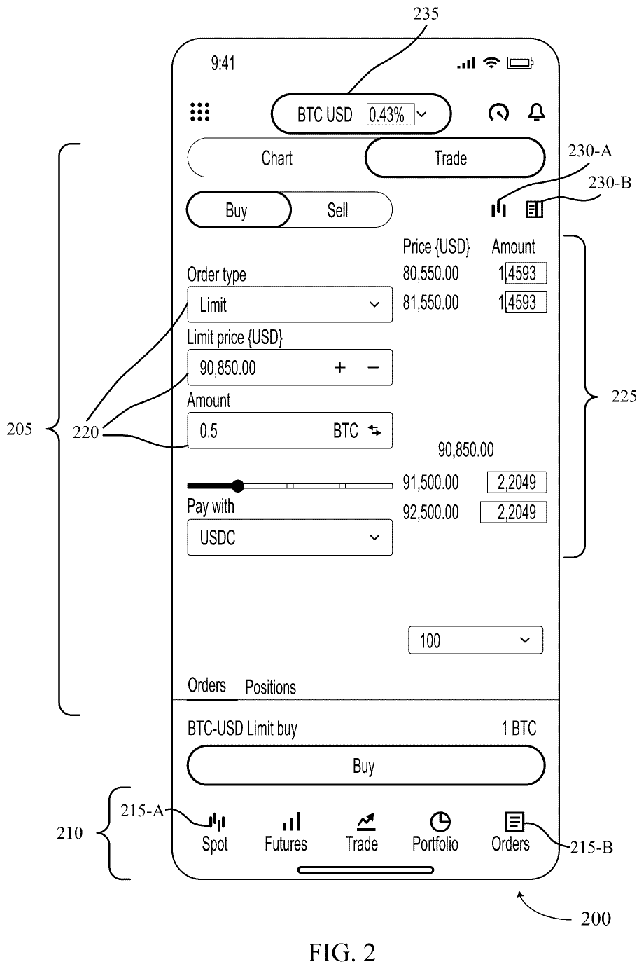

FIG. 2 shows an example of a user interface 200 of a mobile application for a custodial token platform in accordance with aspects of the present disclosure. The user interface 200 of the mobile application includes a user interface page 205 that includes various user interface elements associated with exchange of a first crypto token. As illustrated, the first crypto token is bitcoin (BTC), but it should be understood that the user interface page 205 may display information for other crypto tokens such as ETH. The mobile application may be an example of an application that is used to access various services supported by a custodial token platform, such as custodial token platform 110 of FIG. 1.

The user interface 200 includes a tab section 210, which includes various user interface components (tab user interface components 215), such as tab user interface component 215-b, for user navigation between various user interface pages of the mobile application. The user interface page 205 of the mobile application includes a set of fields 220 that allow a user to enter information associated with placing an exchange order for the first crypto token. For example, the user may change the order type, enter target prices, a purchase amount, and a payment type (e.g., USDC). Additionally, the user interface page 205 includes a dynamically updated order book 225 (e.g., a depth chart), which shows a depth of orders at various target prices. The dynamically updated order book is periodically (e.g., every one or more second, every one or more milliseconds) with changes based on placed orders across the custodial token platform. The mobile application allows the user to select a line (e.g., a price) in the order book, and selection of the price may result in population of one or more of the set of fields 220. The field that is populated may be dependent on the type of order (e.g., limit order, stop limit) that is selected.

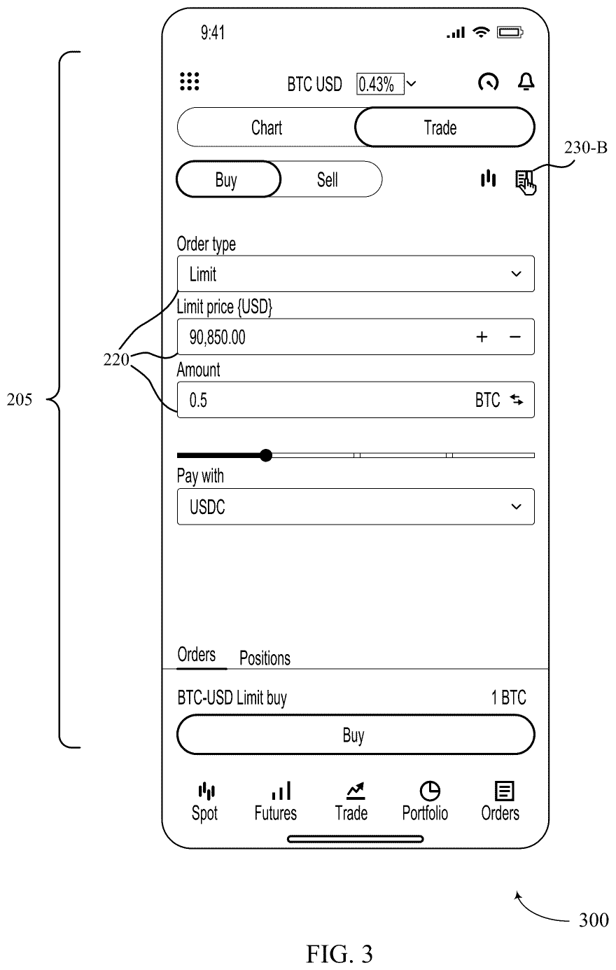

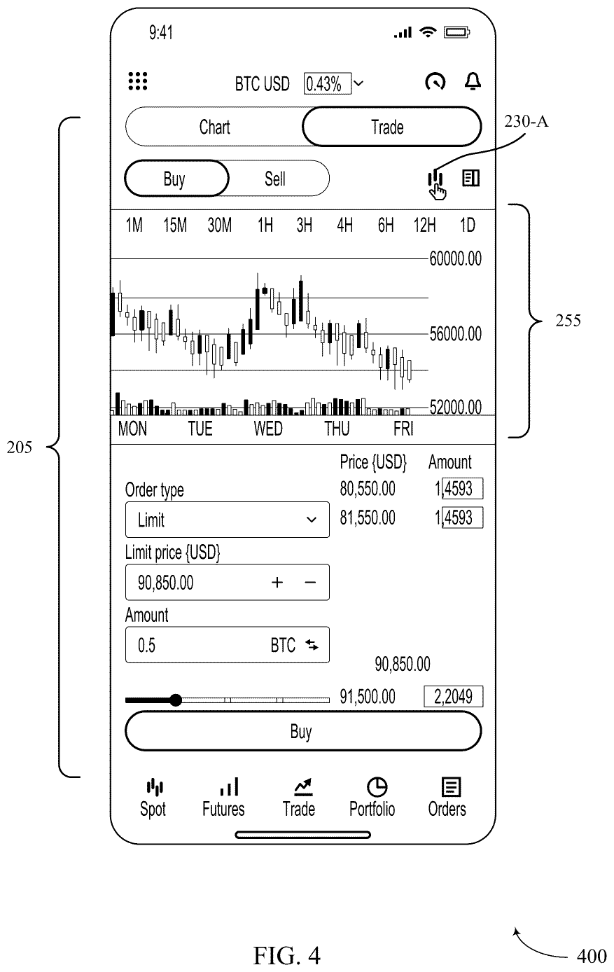

The user may also toggle the type of currency/token that is used for the order basis. For example, the user may select “USD” within the field to toggle between USD and a BTC basis. Additionally, the user interface page 205 includes user interface buttons 230, which support selectively hiding or displaying user interface components. For example, selection of the user interface button 230-a may toggle display of a dynamically updated chart (as shown and described with respect to FIG. 4). Additionally, selection of the user interface button 230-b may toggle display of the order book 225. As described in further detail with respect to FIG. 3, when the order book 225 is hidden via selection of the user interface button 230-b, the set of fields 220 may be resized such as to account for some of the position of the user interface page 205 used by the order book 225, thus allowing users to have a fuller view of an order to be placed to cause an order to be opened at the exchange. As described herein, the order book and associated trading chart support users analyzing complex information to place orders, trades, positions, etc. The small display screen of a mobile device at which the mobile application is being executed limits the amount of information that is displayable. However, the techniques described herein allow for multiple types of dynamically updated information (e.g., order books, charts) to be displayed on the spatially limited display screen. Additionally, such information may be toggled to allow the user to input information (e.g., in the fields) to place orders and positions. As the files are toggled to replace portions of the order book, the fields are larger to allow the user to have a full view of the fields input information. Additionally, as described herein, when some information is hidden, the mobile application may not dynamically update such information, which supports further technical advantage. Thus, the combination of hiding information and expanding fields, in addition to various other user interface flows described herein, results in technical improvement in mobile application frameworks.

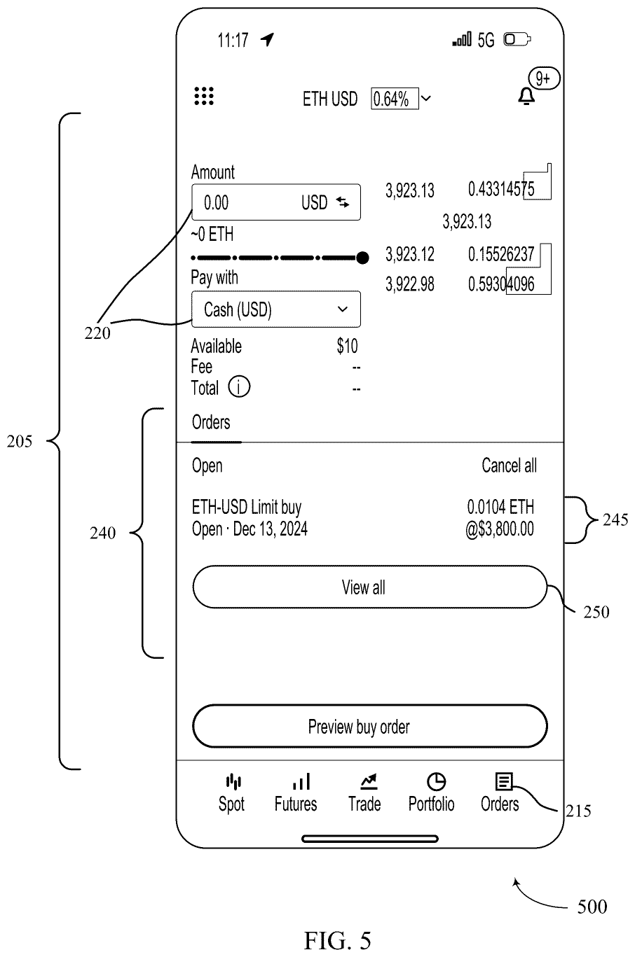

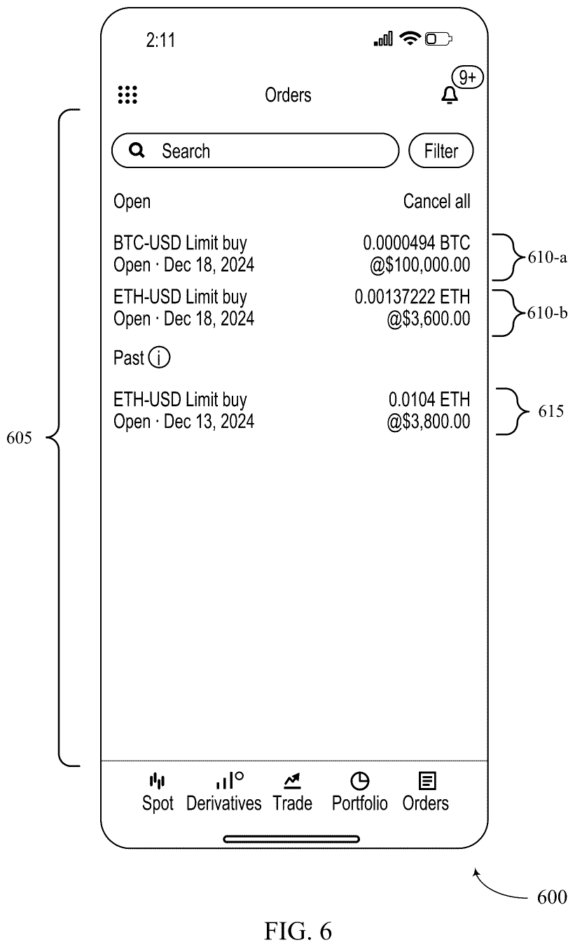

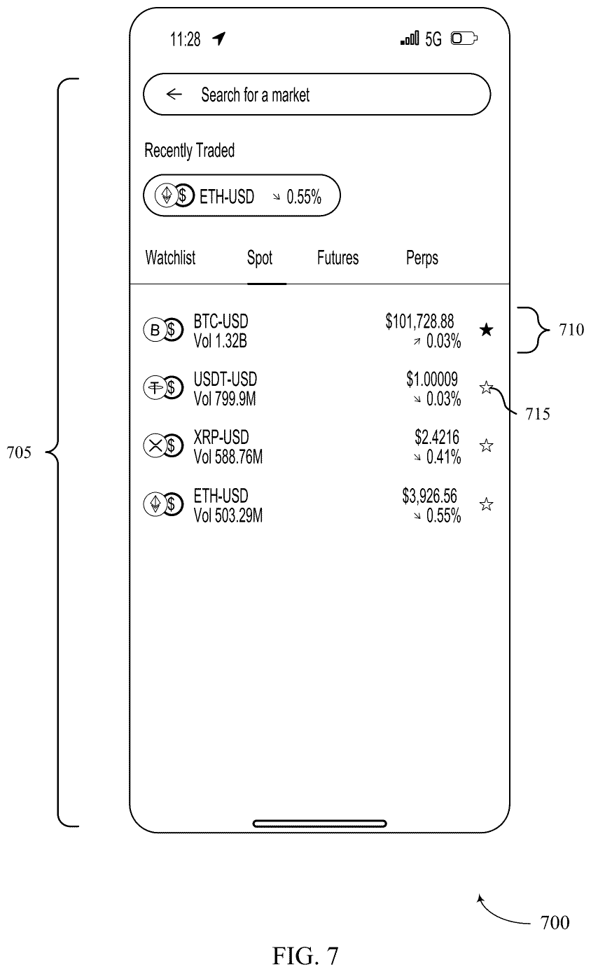

Moreover, the user may also scroll (e.g., via a swipe user input) to move the set of fields 220 and the order book 225 higher within the user interface page 205 and cause display of an orders section, as described in further detail with respect to FIG. 5. The user may use various techniques for navigating between user interface pages as described herein. In one example, after navigating to the orders section of the user interface pace, the user may activate a user interface button to navigate to a orders user interface page that displays open orders for multiple crypto tokens, as shown in FIG. 6. The user may also navigate to the orders user interface page by activating the tab user interface component 215-b. As another example of navigation between user interface pages of the mobile application, the user may select (e.g., causing user input to be received) a pill button 235, which causes display of a market selection page (as shown in FIG. 7), which allows the user to select different crypto tokens for trading or viewing asset detail pages corresponding to selected token. For example, the user may select a different token after selection of the pill button 235, and another instance of the user interface page 205 showing information associated with the selected crypto token may be displayed.

FIG. 3 shows an example of a user interface 300 of a mobile application for a custodial token platform in accordance with aspects of the present disclosure. The user interface 200 of the mobile application may be an example of the user interface 200 illustrated with respect to FIG. 2. The user interface 200 includes the user interface page 205 shown in FIG. 2. However, the user interface page 205 illustrates how the set of fields are resized in response to a user selecting (e.g., providing user input) the user interface button 230-b of the user interface page 205. In response to the user selecting the button, the fields are resized to be positioned within at least a portion of the user interface page that included the order book 225. Thus, the order book 225 is hidden in the user interface page 205 of FIG. 3. The user may toggle display of the order book 225 may selecting the user interface button 230-b. As described with respect to FIG. 2, the order book 225 may be dynamically updated. However, when the order book is hidden via selection of the user interface button 230-b, dynamic updates may not occur (e.g., the current order book status is not fetched), which may result in reduced resource overhead. For example, the mobile application may be configured to continuously or periodically fetch order book when the order book 225 is displayed, but when the chart is toggled off, the mobile application may be configured to cease fetching the order book data, which may result in improved resource utilization by the mobile application. Additionally, as described with respect to FIG. 2, the user may scroll the user interface page 205 to view the orders section, which is described in further detail with respect to FIG. 4.

FIG. 4 shows an example of a user interface 400 of a mobile application for a custodial token platform in accordance with aspects of the present disclosure. The user interface 200 of the mobile application may be an example of the user interface 200 illustrated with respect to FIG. 2. The user interface 200 includes the user interface page 205 shown in FIG. 2. However, the user interface page 205 includes a dynamically updated exchange chart 255. In the illustrated example, the dynamically updated exchange chart 255 is a candlestick chart, but other types of charts are covered within the scope of the present disclosure.

The dynamically updated exchange chart 255 may be toggled on and off via the user interface button 230-a. For example, selection of the user interface button 230-a (e.g., a user input) causes display of the dynamically updated exchange chart 255 within the user interface page 205. When the dynamically updated exchange chart 255 is displayed, the fields (e.g., set of fields 220) associated with placing an exchange order may be repositioned lower within the user interface page. Additionally, while the dynamically updated exchange chart 255 is displayed, the chart may be updated based on recent trading activity associated with the token. Thus, the mobile application may fetch exchange data or chart data to update the chart (e.g., from the custodial token platform). When the chart is hidden (e.g., toggled off), the mobile application may refrain from fetching chart data, thus resulting in improved utilization of computing resources at the computing device executing the mobile application. For example, the mobile application may be configured to continuously or periodically fetch chart data when the chart is displayed, but when the chart is toggled off, the mobile application may be configured to cease fetching the chart data, which may result in improved resource utilization by the mobile application.

FIG. 5 shows an example of a user interface 500 of a mobile application for a custodial token platform in accordance with aspects of the present disclosure. The user interface 500 of the mobile application may be an example of the user interface 200 illustrated with respect to FIG. 2. The user interface 500 includes the user interface page 205 shown in FIGS. 2 through 4. However, the user interface page 205 shows an orders section 240, which is displayed after the user provides user input to scroll the user interface page. The orders section 240 of the user interface page 205 includes information about one or more open orders for the token associated with the user interface page 205. For example, information associated with an open order 245 is illustrated in the orders section 240 of the user interface page 205. In some cases, the orders section 240 includes two or more tabs, which may be used to navigate between different types of trades. For example, the user may select a “positions” tab within the orders section 240 that allows the user to view open positions (e.g., in derivative markets, such as futures and perpetual futures markets) associated with multiple tokens.

Additionally, the orders section 240 includes a user interface button 250, which is associated with viewing open orders for multiple crypto tokens (in addition to the open orders at the user interface page). For example, if the user selects the button 250, the user may navigate to an orders user interface page, as described in further detail with respect to FIG. 6, which shows open orders (in addition to previous/closed orders) for multiple crypto tokens. Further, as described herein, the user may navigate to the orders user interface page by selecting the tab user interface component 215-b, thus providing multiple ways to navigate to the orders user interface page.

FIG. 6 shows an example of a user interface 600 of a mobile application for a custodial token platform in accordance with aspects of the present disclosure. The user interface 600 is an example user interface supported by a mobile application as described herein. The mobile application may be an example of an application that is used to access various services supported by a custodial token platform, such as custodial token platform 110 of FIG. 1. The user interface 600 includes a user interface page 605, which may be an example of an orders user interface page as described herein with respect to FIGS. 1 through 4.

The user interface page 605 includes multiple open orders 610 associated with different crypt tokens (e.g., BTC and ETH). The user interface page 605 also includes a closed order 615. As described herein, the user interface page 605 may be accessed (e.g., navigated to) using various user inputs. In one example, a user may navigate to the user interface page 605 by selecting a button in an orders section in a trading user interface page, such as the user interface button 250 in the orders section 240 of the user interface page 205 as described with respect to FIG. 4. In another example, the user interface page 605 may be accessed by clicking the tab user interface component 215-b shown in the user interfaces illustrated with respect to FIGS. 1 through 4.

FIG. 7 shows an example of a user interface 700 of a mobile application for a custodial token platform in accordance with aspects of the present disclosure. The user interface 700 of the mobile application includes a user interface page 705 includes entries for multiple tokens (e.g., multiple token trading pairs). The user may select one of the entries, such as an entry 710 (e.g., BTC-USD) to navigate to the trading page (e.g., user interface page 205) associated with the selected entry.

The user may navigate to the user interface page 705 (e.g., a market selection page) by selecting a pill button, such as the pill button 235 of FIG. 2. The user may navigate between various market types at the user interface page 705 by selecting tabs associated with the different market types, such as a watchlist tab, spot tab, futures tab, and perpetual futures tab (“perps”). Under each tab, information associated with various tokens and markets may be displayed and selected. Additionally, a user may activate a user interface component (e.g., user interface component 715) to add a token (trading pair) to the watchlist tab.

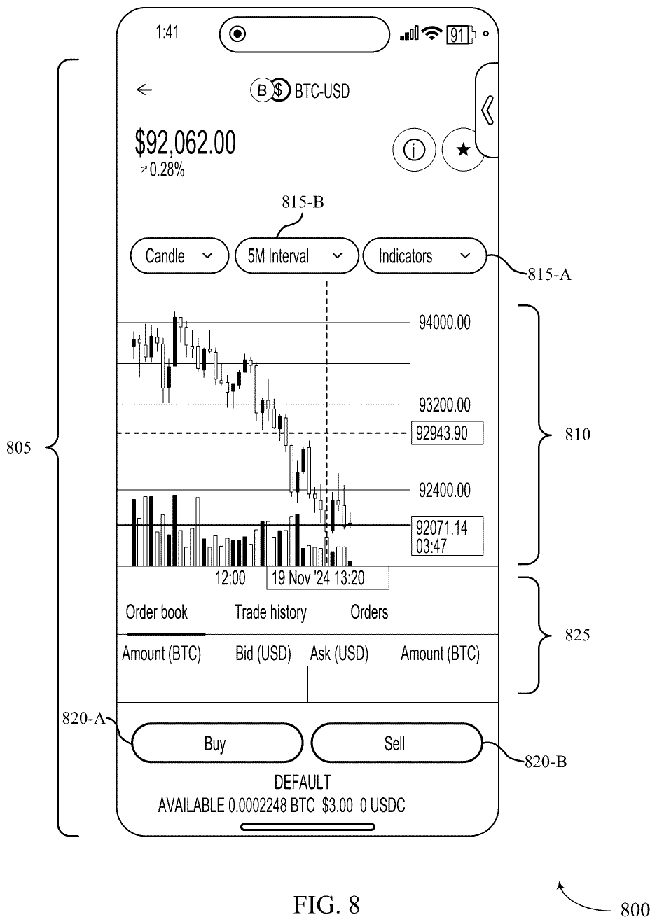

FIG. 8 shows an example of a user interface 800 of a mobile application for a custodial token platform in accordance with aspects of the present disclosure. The user interface 800 is an example user interface supported by a mobile application as described herein. The mobile application may be an example of an application that is used to access various services supported by a custodial token platform, such as custodial token platform 110 of FIG. 1. The user interface 800 includes a user interface page 805, which may be an example of an asset detail page. The user interface page includes a dynamically updated exchange chart 810.

The dynamically updated exchange chart 810 may be an example of the dynamically updated exchange chart 255 as described herein with respect to FIG. 4 and displays exchange data associated with a crypto token. However, the user interface page 805 includes user interface components, such as a user interface component 815-a and a user interface component 815-b. The user interface component may allow a user (e.g., via a user input) to selectively modify aspects of the dynamically updated exchange chart 810. For example, the user may selectively modify the display interval (e.g., 5 minute interval, 1 hour interval) of the dynamically updated exchange chart 810. Additionally, the user may utilize the user interface component 815-a to add trading indicators to the dynamically updated exchange chart 810. Trading indicators may include a relative strength index (RSI), an exponential moving average (EMA), a moving average (MA), a moving average convergence/divergence (MACD), Bollinger bands (BOLL), and the like. For example, selection of the user interface component 815-a may result in display of a toast user interface component with toggles adding/removing trading indicators from the dynamically updated exchange chart 810. However, the user interface page 205 including the dynamically updated exchange chart 255 of FIG. 4 may not include the user interface components 815 that allow the user to adjust aspects of the dynamically updated exchange chart 255.

The user interface page 805 also includes user interface buttons 820-b. Selection of either of the user interface buttons 820 may cause the mobile application to navigate to the trade page of the mobile application, such as the user interface page 205 as described herein with respect to FIGS. 2 through 5, which allows the user to place orders corresponding to the crypto token. The user interface page 805 may also include a section 825 below the dynamically updated exchange chart which allows the user to view additional information associated with the crypto token. For example, the section 825 includes an order book section for viewing a dynamically updated order book (e.g., depth chart) for the token, a trade history section that includes information about previously executed trades across the platform, and an orders section that includes open and closed orders for the crypto token. The orders section may also include a button (e.g., user interface button 250) that may be used to navigate to the orders detail page (e.g., the user interface page 605) including information on open orders for multiple crypto tokens. The user may navigate between the various subsections of section 825 by providing user input (e.g., selecting) a corresponding tab.

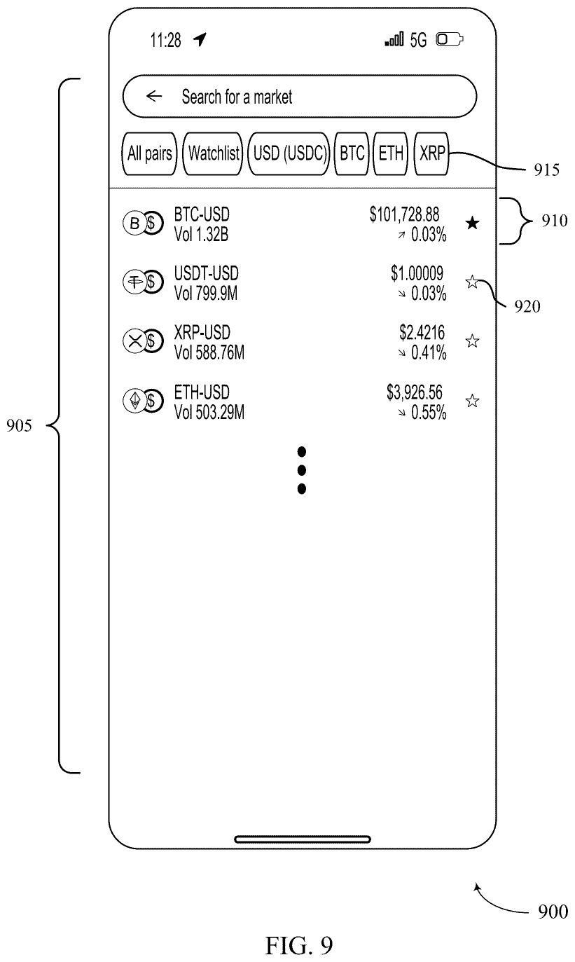

FIG. 9 shows an example of a user interface 900 of a mobile application for a custodial token platform in accordance with aspects of the present disclosure. The user interface 900 is an example user interface supported by a mobile application as described herein. The mobile application may be an example of an application that is used to access various services supported by a custodial token platform, such as custodial token platform 110 of FIG. 1. The user interface 900 includes a user interface page 805, which may be an example of a market detail page.

The user interface page 905 shows entries for spot market pairs for spot market trading. The user interface page 905 may be accessed by selecting a tab user interface component, such as tab user interface component 215-a of FIG. 2. Similar market detail pages may be accessible via other user interface buttons, such as the futures button. Selection of an entry, such as entry 910, within the user interface page 905 may cause the mobile application to display an asset detail page, such as user interface page 805 of FIG. 8, corresponding to the selected entry. The user interface page 905 may also include user interface buttons, such as a button 915, that allow a user to navigate (e.g., via a user input) to a market detail page with trading pairs corresponding to the selected button. The user may also add trading pairs to a user watchlist by activating a button on an entry, such as a button 920.

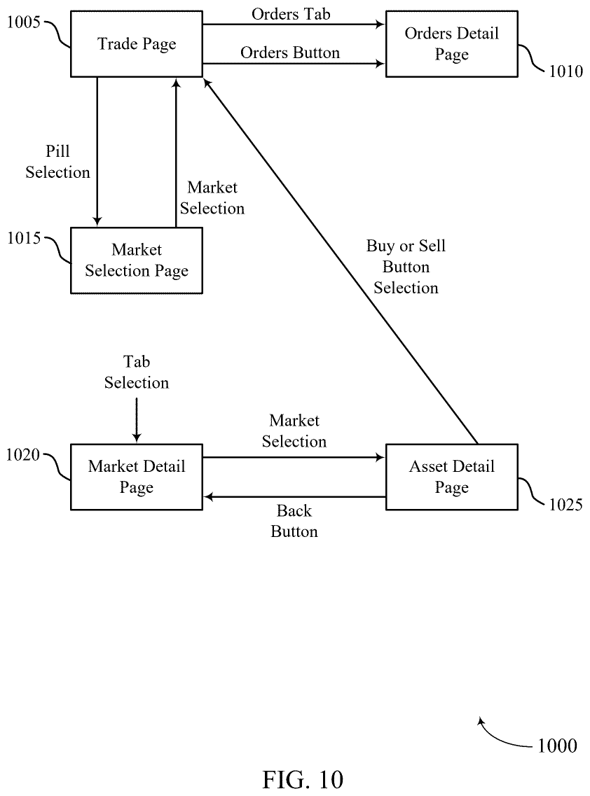

FIG. 10 shows an example of a user interface flow 1000 of a mobile application for a custodial token platform in accordance with aspects of the present disclosure. The user interface flow 1000 may be implemented by a mobile application as described herein. For example, the user interface flow 1000 may be implemented by a mobile application of a custodial token platform, such as custodial token platform 110 of FIG. 1. Alternative examples of the following may be implemented, where some operations are performed in a different order than described or are not performed at all. In some examples, operations may include additional features not mentioned below, or further operations may be added.

The mobile application may display a trade page 1005, which may be an example of the user interface page 205, and the trade page 1005 page may be associated with exchange of a first crypto token and may include a set of fields associated with an exchange order for the first crypto token and a dynamically updated order book associated with exchange of the first crypto token. User input at the trade page 1005 may cause display an orders section within the first user interface page trade page, and the orders section may include one or more first open exchange orders associated with the first crypto token and a user interface button associated with viewing open exchange orders for multiple crypto tokens. In some cases, the mobile application may receive, at the trade page 1050, user input selecting an order book line within the dynamically updated order book. In such cases, the mobile application may populate a field of the exchange order with a price value corresponding to the selected order book line.

The trade page may include one or more user interface buttons associated with hiding or displaying user interface components within the first user interface page. For example, the mobile application may receive, at a first user interface button of the one or more user interface buttons, a user input selecting the first user interface button. The mobile application may display, in response to receiving the user input, a dynamically updated exchange chart associated with exchange of the first crypto token. Additionally, or alternatively, the mobile application may receive, at a second user interface button of the one or more user interface buttons, a user input selecting the second user interface button. The mobile application may remove, in response to receiving the user input, display of the dynamically updated order book associated with exchange of the first crypto token. In some cases, the mobile application may resize the set of fields to at least partially replace a position in the first user interface page that displayed the dynamically updated order book.

The mobile application may display an orders detail page 1010 (e.g., the user interface page 605) in response to receiving a user input selecting the user interface button in the orders section of the trade page 1005. In some cases, the mobile application may display (e.g., in association with various user interface pages of the mobile application) one or more tab user interface components. The user may select the orders tab, which may result in display of the orders detail page 1010.

In some cases, the mobile application may display a market selection page 1015 in response to user input selecting a user interface component including information associated with the crypto asset that is associated with the information displayed in the trade page 1005. For example, the user input may select a pill button 235 (e.g., a user interface component) of the user interface page 205. The market selection page 1015 may display a list of entries for the plurality of crypto tokens including the first crypto token. If the user selects another crypto token, such as a second crypto token at the market selection page 1015, then the mobile application may display an instance of the trade page 1005 with information (e.g., set of fields, order book) associated with the second crypto token.

In some cases, the mobile application may receive user input that selects a tab, which may result in the mobile application displaying a market detail page 1020 (e.g., the user interface page 905), which includes entries for multiple crypto tokens. Selection of the entries may result in the mobile application displaying an asset detail page 1025 (e.g., the user interface page 805). The asset detail page may include a dynamically updated exchange chart associated with exchange of the first crypto token, and the asset detail page may include one or more user interface buttons associated with selectively displaying exchange indicators in associated with the dynamically updated exchange chart, modifying an interval associated with the second dynamically updated exchange chart, or both. As described herein, the dynamically updated exchange chart of the trade page 1005 may be displayed without the one or more user interface buttons for selectively displaying exchange indicators or modifying the interval. At the asset detail page, the mobile application may receive user input (e.g., selection of a back button), which may cause the mobile application to display the market detail page 1020. Additionally, or alternatively, the mobile application may receive user input at the asset detail page 1025 (e.g., selection of a buy or sell user interface button), which may result in display of the trade page 1005 by the mobile application.

Thus, in accordance with the user interface flow, multiple techniques may be used to navigate to different pages. These different techniques may result in technical improvements relative to previous mobile application frameworks, in addition to improved user experience. For example, the asset detail page 1025 may display the dynamically updated exchange chart in a relatively limited display area of a mobile device and may support advanced (typically reserved for larger display screens) metrics (e.g., indicators) and adjustments (e.g., intervals). Similar chart information may be displayed at the trade page 1005, but due to other functionality (e.g., placing traders, orders, positions) at the trade page, the advanced metrics and adjustments may not be available. However, the user may still use (and toggle) the chart for information in placing an order, in addition to toggling the chart (and order book) to input information to place the order in the small display area of a mobile device. The display and toggling of such information and support of various user navigations is a technical improvement in mobile application framework as other mobile applications may require a user to navigate to multiple pages to view charts, order books, etc. and to navigate to a specific and separate order page to input the information to place a trade, order, or position. These other applications may require a user to leave a page with relevant information that is used to place a trade, order, or position. Thus, the techniques described herein address technical and user experience related problems with other applications and small form factors of mobile devices.

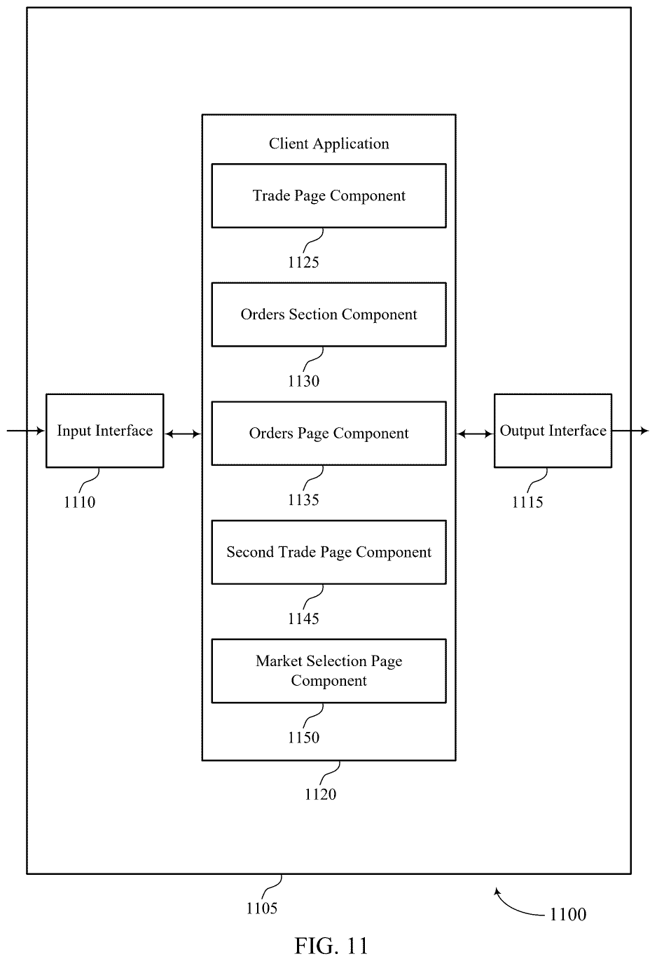

FIG. 11 shows a block diagram 1100 of a device 1105 (e.g., a mobile device) that supports user interfaces of a mobile application for a custodial token platform in accordance with aspects of the present disclosure. The device 1105 may include an input interface 1110, an output interface 1115, and a client application 1120 (e.g., a mobile application). The device 1105, or one or more components of the device 1105 (e.g., the input interface 1110, the output interface 1115, the client application 1120), may include at least one processor, which may be coupled with at least one memory, to support the described techniques. Each of these components, or components of subcomponents thereof (e.g., one or more processors, one or more memories), may communicate, directly or indirectly, with one another (e.g., via one or more buses, communications links, communications interfaces, or any combination thereof).

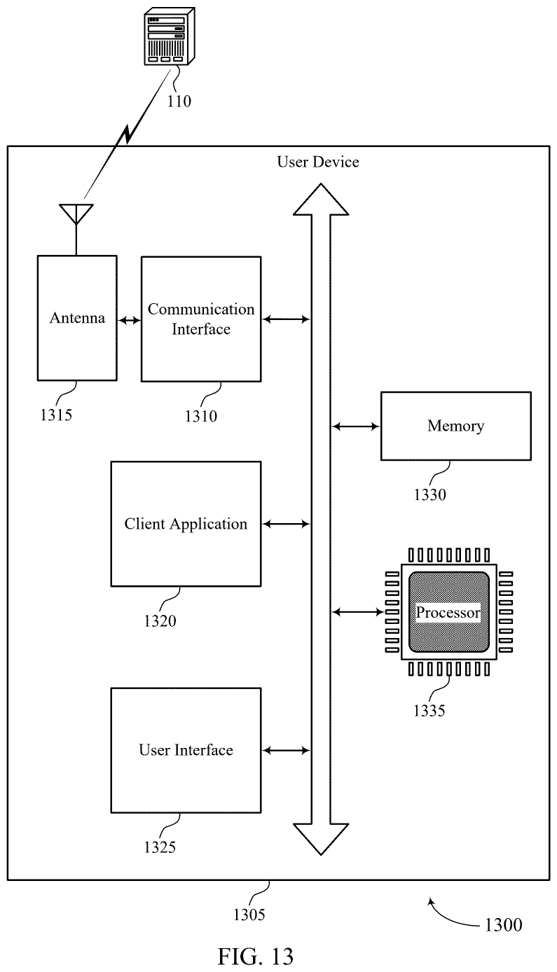

The input interface 1110 may manage input signaling for the device 1105. For example, the input interface 1110 may receive input signaling (e.g., messages, packets, data, instructions, commands, transactions, or any other form of encoded information) from other systems or devices. The input interface 1110 may send signaling corresponding to (e.g., representative of or otherwise based on) such input signaling to other components of the device 1105 for processing. For example, the input interface 1110 may transmit such corresponding signaling to the client application 1120 to support user interfaces of a mobile application for a custodial token platform. In some cases, the input interface 1110 may be a component of a communication interface 1310 as described with reference to FIG. 13.

The output interface 1115 may manage output signaling for the device 1105. For example, the output interface 1115 may receive signaling (e.g., messages, packets, data, instructions, commands, transactions, or any other form of encoded information) from other components of the device 1105, such as the client application 1120 and may transmit output signaling corresponding to {e.g., representative of or otherwise based on) such signaling to other systems or devices to support user interfaces of a mobile application for a custodial token platform. In some cases, the output interface 1115 may be a component of the communication interface 1310 as described with reference to FIG. 13

For example, the client application 1120 may include a trade page component 1125, an orders section component 1130, an orders page component 1135, a second trade page component 1145, a market selection page component 1150, or any combination thereof. In some examples, the client application 1120, or various components thereof, may be configured to perform various operations (e.g., receiving, monitoring, transmitting) using or otherwise in cooperation with the input interface 1110, the output interface 1115, or both. For example, the client application 1120 may receive information from the input interface 1110, send information to the output interface 1115, or be integrated in combination with the input interface 1110, the output interface 1115, or both to receive information, transmit information, or perform various other operations as described herein.

The trade page component 1125 may be configured as or otherwise support a means for displaying a first user interface page of a mobile application at a mobile device, the first user interface page associated with exchange of a first crypto token and comprising a set of fields associated with an exchange order for the first crypto token and a dynamically updated order book associated with exchange of the first crypto token. The orders section component 1130 may be configured as or otherwise support a means for displaying, in response to detecting a first user input at the first user interface page, an orders section within the first user interface page and including one or more first open exchange orders associated with the first crypto token and a user interface button associated with viewing open exchange orders for a plurality of crypto tokens. The orders page component 1135 may be configured as or otherwise support a means for displaying, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

The trade page component 1125 may be configured as or otherwise support a means for displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token. The second trade page component 1145 may be configured as or otherwise support a means for displaying, in response to receiving one or more first user inputs at the first user interface page, a second user interface page associated with exchange of a second crypto token and comprising a second set of fields associated with a second exchange order for the second crypto token and a second dynamically updated order book associated with exchange of the second crypto token. The market selection page component 1150 may be configured as or otherwise support a means for displaying, in response to receiving one or more second user inputs, a third user interface page comprising a list of entries for a plurality of crypto tokens including the first crypto token and the second crypto token. The trade page component 1125 may be configured as or otherwise support a means for displaying, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

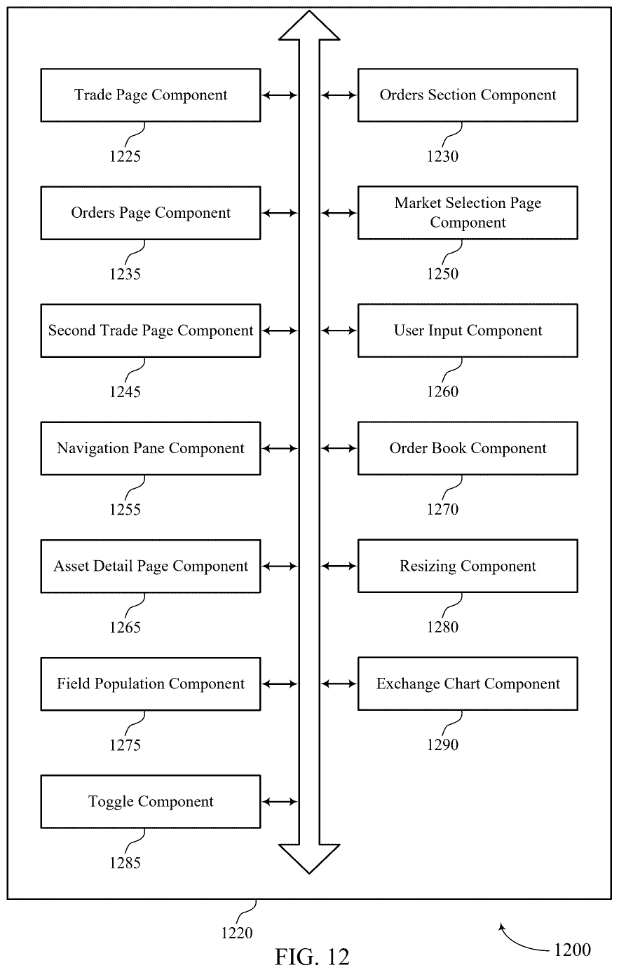

FIG. 12 shows a block diagram 1200 of a client application 1220 of a mobile application for a custodial token platform in accordance with aspects of the present disclosure. The client application 1220 may be an example of aspects of a client application or a client application 1120, or both, as described herein. The client application 1220, or various components thereof, may be an example of means for performing various aspects of user interfaces of a mobile application for a custodial token platform as described herein. For example, the client application 1220 may include a trade page component 1225, an orders section component 1230, an orders page component 1235, a second trade page component 1245, a market selection page component 1250, a navigation pane component 1255, a user input component 1260, an asset detail page component 1265, an order book component 1270, a field population component 1275, a resizing component 1280, a toggle component 1285, an exchange chart component 1290, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The trade page component 1225 may be configured as or otherwise support a means for displaying a first user interface page of a mobile application at a mobile device, the first user interface page associated with exchange of a first crypto token and comprising a set of fields associated with an exchange order for the first crypto token and a dynamically updated order book associated with exchange of the first crypto token. The orders section component 1230 may be configured as or otherwise support a means for displaying, in response to detecting a first user input at the first user interface page, an orders section within the first user interface page and including one or more first open exchange orders associated with the first crypto token and a user interface button associated with viewing open exchange orders for a plurality of crypto tokens. The orders page component 1235 may be configured as or otherwise support a means for displaying, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

In some examples, the navigation pane component 1255 may be configured as or otherwise support a means for displaying, at the mobile application, two or more tab user interface components, a first tab user interface component associated with viewing open exchange orders for the plurality of crypto tokens. In some examples, the user input component 1260 may be configured as or otherwise support a means for receiving a third user input selecting the first tab user interface component. In some examples, the orders page component 1235 may be configured as or otherwise support a means for displaying, in response to receiving the third user input, the second user interface page comprising the one or more first open exchange orders and the one or more second open exchange orders.

In some examples, the first user interface page further comprises one or more user interface buttons associated with hiding or displaying user interface components within the first user interface page.

In some examples, the toggle component 1285 may be configured as or otherwise support a means for receiving, at a first user interface button of the one or more user interface buttons, a third user input selecting the first user interface button. In some examples, the exchange chart component 1290 may be configured as or otherwise support a means for displaying, in response to receiving the third user input, a dynamically updated exchange chart associated with exchange of the first crypto token.

In some examples, the toggle component 1285 may be configured as or otherwise support a means for receiving, at a first user interface button of the one or more user interface buttons, a third user input selecting the first user interface button. In some examples, the order book component 1270 may be configured as or otherwise support a means for removing, in response to receiving the third user input, display of the dynamically updated order book associated with exchange of the first crypto token.

In some examples, the resizing component 1280 may be configured as or otherwise support a means for resizing the set of fields to at least partially replace a position in the first user interface page that displayed the dynamically updated order book.

In some examples, the trade page component 1225 may be configured as or otherwise support a means for displaying, in response to receiving one or more third user inputs, the first user interface page. In some examples, the market selection page component 1250 may be configured as or otherwise support a means for displaying, in response to receiving a fourth user input selecting a user interface component comprising information associated with the first crypto token, a third user interface page displaying a list of entries for the plurality of crypto tokens including the first crypto token. In some examples, the trade page component 1225 may be configured as or otherwise support a means for displaying, in response to receiving a fifth user input selecting an entry for a second crypto token of the plurality of crypto tokens, a fourth user interface page associated with exchange of the second crypto token and comprising a second set of fields associated with a second exchange order for the second crypto token and a second dynamically updated order book associated with exchange of the second crypto token.

In some examples, the first user interface page comprises a first dynamically updated exchange chart associated with exchange of the first crypto token, and the asset detail page component 1265 may be configured as or otherwise support a means for displaying, in response to receiving one or more third user inputs, a third user interface page comprising a second dynamically updated exchange chart associated with exchange of the first crypto token, wherein the second user interface page comprises one or more user interface buttons associated with selectively displaying exchange indicators in associated with the second dynamically updated exchange chart, modifying an interval associated with the second dynamically updated exchange chart, or both, and wherein the first user interface page comprises the first dynamically updated exchange chart without the one or more user interface buttons.

In some examples, the order book component 1270 may be configured as or otherwise support a means for receiving, at the first user interface page, a third user input selecting an order book line within the dynamically updated order book. In some examples, the field population component 1275 may be configured as or otherwise support a means for populating a field of the set of fields associated with the exchange order with a price value corresponding to the selected order book line.

In some examples, the trade page component 1225 may be configured as or otherwise support a means for displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token. The second trade page component 1245 may be configured as or otherwise support a means for displaying, in response to receiving one or more first user inputs at the first user interface page, a second user interface page associated with exchange of a second crypto token and comprising a second set of fields associated with a second exchange order for the second crypto token and a second dynamically updated order book associated with exchange of the second crypto token. The market selection page component 1250 may be configured as or otherwise support a means for displaying, in response to receiving one or more second user inputs, a third user interface page comprising a list of entries for a plurality of crypto tokens including the first crypto token and the second crypto token. In some examples, the trade page component 1225 may be configured as or otherwise support a means for displaying, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

In some examples, the asset detail page component 1265 may be configured as or otherwise support a means for displaying, in response to receiving the third user input at the third user interface page, a fourth user interface page comprising a first dynamically updated exchange chart associated with exchange of the first crypto token, the fourth user interface page comprising one or more buttons associated with placing the first exchange order for the first crypto token, wherein displaying the first user interface page comprises. In some examples, the trade page component 1225 may be configured as or otherwise support a means for displaying the first user interface page in response to receiving a fourth user input at the fourth user interface page, the fourth user input selecting a button of the one or more buttons associated with placing the first exchange order.

In some examples, the fourth user interface page comprising the first dynamically updated exchange chart comprises one or more user interface buttons associated with selectively displaying exchange indicators associated with the first dynamically updated exchange chart, modifying an interval associated with the first dynamically updated exchange chart, or both. In some examples, the first user interface page comprises a second dynamically updated exchange chart without the one or more user interface buttons.

In some examples, the first user interface page further comprises one or more user interface buttons associated with hiding or displaying user interface components within the first user interface page.

In some examples, the toggle component 1285 may be configured as or otherwise support a means for receiving, at a first user interface button of the one or more user interface buttons, a fourth user input selecting the first user interface button. In some examples, the exchange chart component 1290 may be configured as or otherwise support a means for displaying, in response to receiving the third user input, a dynamically updated exchange chart associated with exchange of the first crypto token.

In some examples, the toggle component 1285 may be configured as or otherwise support a means for receiving, at a first user interface button of the one or more user interface buttons, a third user input selecting the first user interface button. In some examples, the exchange chart component 1290 may be configured as or otherwise support a means for removing, in response to receiving the third user input, display of the first dynamically updated order book associated with exchange of the first crypto token.

In some examples, the resizing component 1280 may be configured as or otherwise support a means for resizing the second set of fields to at least partially replace a position in the first user interface page that displayed the first dynamically updated order book.

In some examples, the orders section component 1230 may be configured as or otherwise support a means for displaying, in response to receiving a fourth user input at the first user interface page, an orders section within the first user interface page and including one or more first open exchange orders associated with the first crypto token and a user interface button associated with viewing open exchange orders for the plurality of crypto tokens. In some examples, the orders page component 1235 may be configured as or otherwise support a means for displaying, in response to receiving a fifth user input selecting the user interface button in the orders section, a third user interface page of the mobile application, the third user interface page comprising the one or more first open exchange orders associated with the first crypto token and one or more second open exchange orders associated with the second crypto token of the plurality of crypto tokens.

In some examples, the navigation pane component 1255 may be configured as or otherwise support a means for displaying, at the mobile application, two or more tab user interface components, a first tab user interface component associated with viewing open exchange orders for the plurality of crypto tokens. In some examples, the user input component 1260 may be configured as or otherwise support a means for receiving a sixth user input selecting the first tab user interface component. In some examples, the orders page component 1235 may be configured as or otherwise support a means for displaying, in response to receiving the sixth user input selecting the first tab user interface component, the third user interface page comprising the one or more first open exchange orders associated with the first crypto token and the one or more second open exchange orders associated with the second crypto token of the plurality of crypto tokens.

FIG. 13 shows a diagram of a system 1300 including a device 1305 that supports user interfaces of a mobile application for a custodial token platform in accordance with aspects of the present disclosure. The device 1305 may be an example of or include components of a device 1105 as described herein. The device 1305 may include components for bi-directional voice and data communications including components for transmitting and receiving communications, such as a client application 1320, a communication interface 1310, one or more antennas 1315, a user interface component 1325, at least one memory 1330, and at least one processor 1335. Each of these components, or components of subcomponents thereof (e.g., one or more processors, one or more memories), may communicate, directly or indirectly, with one another (e.g., via one or more buses, communications links, communications interfaces, or any combination thereof).

The communication interface 1310 may manage input and output signals for the device 1305 via the antenna 1315. For example, the communication interface 1310 may enable the user device 1305 to exchange information (e.g., input information, output information, or both) with other systems or devices, such as custodial token platform 110 (e.g., supported by one or more servers), via one or more wired or wireless communication links. The communication interface 1310 may also utilize or interact with antenna 1315 to support communication with other systems or devices. In some cases, the communication interface 1310 may represent a physical connection or port to an external peripheral, such as a hardware wallet device. In some cases, the communication interface 1310 may utilize an operating system such as iOS®, ANDROID®, MS-DOS®, MS-WINDOWS®, OS/2®, UNIX®, LINUX®, or another known operating system. The communication interface 1310 may be implemented as part of the processor 1335.

In some cases, the device 1305 may include a single antenna 1315. However, in some other cases, the device 1305 may have more than one antenna 1315, which may be capable of concurrently transmitting or receiving multiple wireless transmissions. The communication interface 1310 may communicate bi-directionally, via the one or more antennas 1315, wired, or wireless links as described herein. For example, the communication interface 1310 may represent a wireless transceiver and may communicate bi-directionally with another wireless transceiver. The communication interface 1310 may also include a modem to modulate the packets, to provide the modulated packets to one or more antennas 1315 for transmission, and to demodulate packets received from the one or more antennas 1315.

The user interface component 1325 may represent a keyboard, a mouse, a touchscreen, a microphone, or a similar device or component. In some cases, a user may interact with the user interface component 1325. In other cases, the user interface component 1325 may operate automatically without user interaction. The user interface component 1325 may display or output information such as information received from other systems or devices or information to be transmitted to other systems or devices.

The memory 1330 may include RAM and ROM. The memory 1330 may store computer-readable, computer-executable software including instructions that, when executed, cause at least one processor 1335 to perform various functions described herein. In some cases, the memory 1330 may contain, among other things, a BIOS which may control basic hardware or software operation such as the interaction with peripheral components or devices. The memory 1330 may be an example of a single memory or multiple memories. For example, the device 1305 may include one or more memories 1330.

The processor 1335 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1335 may be configured to operate a memory array using a memory controller. In other cases, a memory controller may be integrated into the processor 1335. The processor 1335 may be configured to execute computer-readable instructions stored in at least one memory 1330 to perform various functions (e.g., functions or tasks supporting a method and system for user interfaces of a mobile application for a custodial token platform). Though a single processor 1335 is depicted in the example of FIG. 13, it is to be understood that the user device 1305 may include any quantity of one or more of processors 1335 and that a group of processors 1335 may collectively perform one or more functions ascribed herein to a processor, such as the processor 1335. The processor 1335 may be an example of a single processor or multiple processors. For example, the device 1305 may include one or more processors 1335.

For example, the client application 1320 may be configured as or otherwise support a means for displaying a first user interface page of a mobile application at a mobile device, the first user interface page associated with exchange of a first crypto token and comprising a set of fields associated with an exchange order for the first crypto token and a dynamically updated order book associated with exchange of the first crypto token. The client application 1320 may be configured as or otherwise support a means for displaying, in response to detecting a first user input at the first user interface page, an orders section within the first user interface page and including one or more first open exchange orders associated with the first crypto token and a user interface button associated with viewing open exchange orders for a plurality of crypto tokens. The client application 1320 may be configured as or otherwise support a means for displaying, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

For example, the client application 1320 may be configured as or otherwise support a means for one or more memories storing processor-executable code. The client application 1320 may be configured as or otherwise support a means for one or more processors coupling with the one or more memories and individually or collectively operable to execute the code to cause the apparatus to. The client application 1320 may be configured as or otherwise support a means for displaying a first user interface page of a mobile application at a mobile device, the first user interface page associated with exchange of a first crypto token and comprising a set of fields associated with an exchange order for the first crypto token and a dynamically updated order book associated with exchange of the first crypto token. The client application 1320 may be configured as or otherwise support a means for display, in response to detecting a first user input at the first user interface page, an orders section within the first user interface page and including one or more first open exchange orders associated with the first crypto token and a user interface button associated with viewing open exchange orders for a plurality of crypto tokens. The client application 1320 may be configured as or otherwise support a means for display, in response to receiving a second user input selecting a first tab user interface component displayed by the mobile application, a second user interface page the one or more first open exchange orders associated with the first crypto token and one or more second open exchange orders associated with one or more second crypto tokens of the plurality of crypto tokens.

For example, the client application 1320 may be configured as or otherwise support a means for displaying a first user interface page of a mobile application at a mobile device, the first user interface page associated with exchange of a first crypto token and comprising a set of fields associated with an exchange order for the first crypto token, a dynamically updated order book associated with exchange of the first crypto token, and one or more user interface buttons associated with hiding or displaying user interface components within the first user interface page. The client application 1320 may be configured as or otherwise support a means for display, in response to detecting a first user input at the first user interface page, an orders section within the first user interface page and including one or more first open exchange orders associated with the first crypto token and a user interface button associated with viewing open exchange orders for a plurality of crypto tokens. The client application 1320 may be configured as or otherwise support a means for display, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

For example, the client application 1320 may be configured as or otherwise support a means for displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token. The client application 1320 may be configured as or otherwise support a means for displaying, in response to receiving one or more first user inputs at the first user interface page, a second user interface page associated with exchange of a second crypto token and comprising a second set of fields associated with a second exchange order for the second crypto token and a second dynamically updated order book associated with exchange of the second crypto token. The client application 1320 may be configured as or otherwise support a means for displaying, in response to receiving one or more second user inputs, a third user interface page comprising a list of entries for a plurality of crypto tokens including the first crypto token and the second crypto token. The client application 1320 may be configured as or otherwise support a means for displaying, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

For example, the client application 1320 may be configured as or otherwise support a means for one or more memories storing processor-executable code. The client application 1320 may be configured as or otherwise support a means for one or more processors coupling with the one or more memories and individually or collectively operable to execute the code to cause the apparatus to. The client application 1320 may be configured as or otherwise support a means for displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token. The client application 1320 may be configured as or otherwise support a means for display, in response to receiving at least a first user inputs at the first user interface page, a second user interface page associated with exchange of a second crypto token and comprising a second set of fields associated with a second exchange order for the second crypto token and a second dynamically updated order book associated with exchange of the first crypto token. The client application 1320 may be configured as or otherwise support a means for display, in response to receiving one or more second user inputs, a third user interface page comprising a list of entries for a plurality of crypto tokens including the first crypto token and the second crypto token. The client application 1320 may be configured as or otherwise support a means for displaying, in response to receiving a third user input at the third user interface page, a fourth user interface page comprising a first dynamically updated exchange chart associated with exchange of the second crypto token, the fourth user interface page comprising one or more buttons associated with placing the second exchange order for the second crypto token. The client application 1320 may be configured as or otherwise support a means for display, in response to receiving at least a fourth user input at the fourth user interface page, the first user interface page associated with exchange of the first crypto token and comprising the first set of fields associated with the first exchange order for the first crypto token and the first dynamically updated order book associated with exchange of the first crypto token.

For example, the client application 1320 may be configured as or otherwise support a means for displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token. The client application 1320 may be configured as or otherwise support a means for display, in response to receiving at least a first user inputs at the first user interface page, a second user interface page associated with exchange of a second crypto token and comprising a second set of fields associated with a second exchange order for the second crypto token, a second dynamically updated order book associated with exchange of the first crypto token, and one or more user interface buttons associated with hiding or displaying user interface components within the second user interface page. The client application 1320 may be configured as or otherwise support a means for display, in response to receiving one or more second user inputs, a third user interface page comprising a list of entries for a plurality of crypto tokens including the first crypto token and the second crypto token. The client application 1320 may be configured as or otherwise support a means for display, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

By including or configuring the client application 1320 in accordance with examples as described herein, the device 1305 may support techniques for improved user experience related to efficient use of mobile device displays for advanced trading techniques.

The client application 1320 may include an application (e.g., “app”), program, software, extension, or other component which is configured to facilitate communications with a custodial token platform 110 on a server, one or more nodes of a blockchain network 105, other devices 1305, and other devices or systems. For example, the client application 1320 may be an application executable on the device 1305, and the client application 1320 may be configured to receive data from a custodial token platform 110, transmit data to the custodial token platform 110, process such data, and cause presentation of such data to a user via a user interface component 1325. The client application 1320 may be an example of a wallet application, a wallet device, or both, and may be associated with a wallet address and may access or use a private key to sign messages to facilitate transfer of crypto tokens, messages, transactions, or the like via a blockchain distributed data store.

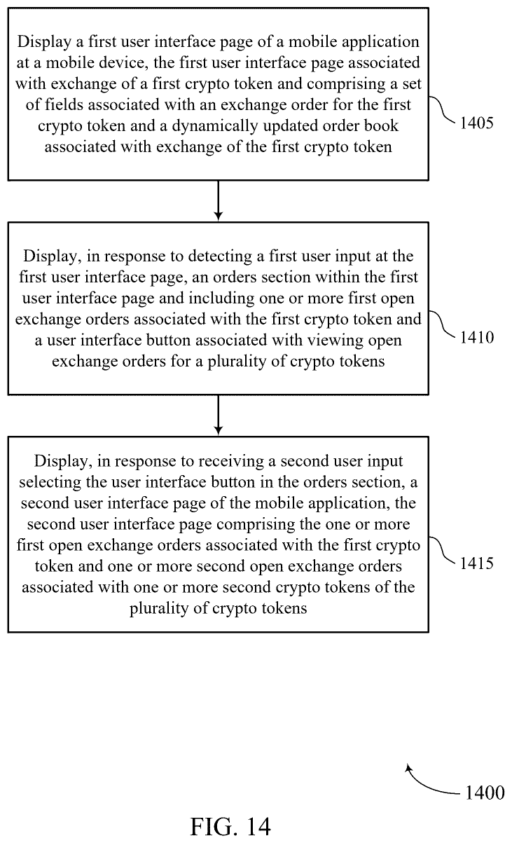

FIG. 14 shows a flowchart illustrating a method 1400 of a mobile application for a custodial token platform in accordance with aspects of the present disclosure. The operations of the method 1400 may be implemented by a user device or its components as described herein. For example, the operations of the method 1400 may be performed by a user device as described with reference to FIGS. 1 through 13. In some examples, a user device may execute a set of instructions to control the functional elements of the user device to perform the described functions. Additionally, or alternatively, the user device may perform aspects of the described functions using special-purpose hardware.

At 1405, the method may include displaying a first user interface page of a mobile application at a mobile device, the first user interface page associated with exchange of a first crypto token and comprising a set of fields associated with an exchange order for the first crypto token and a dynamically updated order book associated with exchange of the first crypto token. The operations of 1405 may be performed in accordance with examples as disclosed herein. In some examples, aspects of the operations of 1405 may be performed by a trade page component 1225 as described with reference to FIG. 12.

At 1410, the method may include displaying, in response to detecting a first user input at the first user interface page, an orders section within the first user interface page and including one or more first open exchange orders associated with the first crypto token and a user interface button associated with viewing open exchange orders for a plurality of crypto tokens. The operations of 1410 may be performed in accordance with examples as disclosed herein. In some examples, aspects of the operations of 1410 may be performed by an orders section component 1230 as described with reference to FIG. 12.

At 1415, the method may include displaying, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens. The operations of 1415 may be performed in accordance with examples as disclosed herein. In some examples, aspects of the operations of 1415 may be performed by an orders page component 1235 as described with reference to FIG. 12.

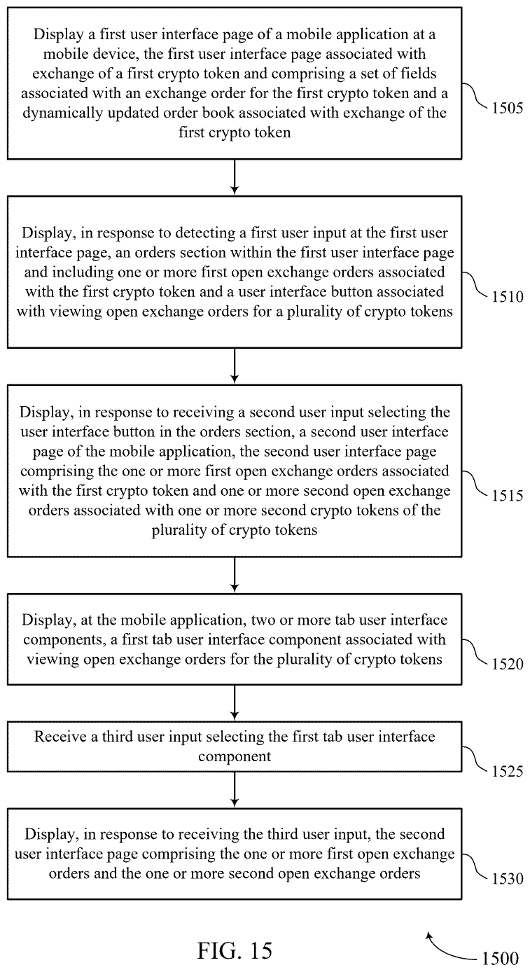

FIG. 15 shows a flowchart illustrating a method 1500 of a mobile application for a custodial token platform in accordance with aspects of the present disclosure. The operations of the method 1500 may be implemented by a user device or its components as described herein. For example, the operations of the method 1500 may be performed by a user device as described with reference to FIGS. 1 through 13. In some examples, a user device may execute a set of instructions to control the functional elements of the user device to perform the described functions. Additionally, or alternatively, the user device may perform aspects of the described functions using special-purpose hardware.

At 1505, the method may include displaying a first user interface page of a mobile application at a mobile device, the first user interface page associated with exchange of a first crypto token and comprising a set of fields associated with an exchange order for the first crypto token and a dynamically updated order book associated with exchange of the first crypto token. The operations of 1505 may be performed in accordance with examples as disclosed herein. In some examples, aspects of the operations of 1505 may be performed by a trade page component 1225 as described with reference to FIG. 12.

At 1510, the method may include displaying, in response to detecting a first user input at the first user interface page, an orders section within the first user interface page and including one or more first open exchange orders associated with the first crypto token and a user interface button associated with viewing open exchange orders for a plurality of crypto tokens. The operations of 1510 may be performed in accordance with examples as disclosed herein. In some examples, aspects of the operations of 1510 may be performed by an orders section component 1230 as described with reference to FIG. 12.

At 1515, the method may include displaying, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens. The operations of 1515 may be performed in accordance with examples as disclosed herein. In some examples, aspects of the operations of 1515 may be performed by an orders page component 1235 as described with reference to FIG. 12.

At 1520, the method may include displaying, at the mobile application, two or more tab user interface components, a first tab user interface component associated with viewing open exchange orders for the plurality of crypto tokens. The operations of 1520 may be performed in accordance with examples as disclosed herein. In some examples, aspects of the operations of 1520 may be performed by a navigation pane component 1255 as described with reference to FIG. 12.

At 1525, the method may include receiving a third user input selecting the first tab user interface component. The operations of 1525 may be performed in accordance with examples as disclosed herein. In some examples, aspects of the operations of 1525 may be performed by a user input component 1260 as described with reference to FIG. 12.

At 1530, the method may include displaying, in response to receiving the third user input, the second user interface page comprising the one or more first open exchange orders and the one or more second open exchange orders. The operations of 1530 may be performed in accordance with examples as disclosed herein. In some examples, aspects of the operations of 1530 may be performed by an orders page component 1235 as described with reference to FIG. 12.

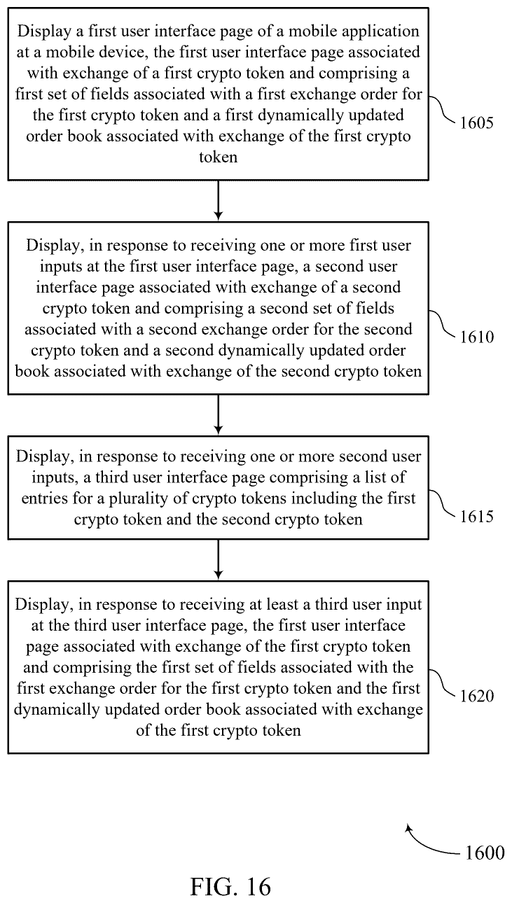

FIG. 16 shows a flowchart illustrating a method 1600 of a mobile application for a custodial token platform in accordance with aspects of the present disclosure. The operations of the method 1600 may be implemented by a user device or its components as described herein. For example, the operations of the method 1600 may be performed by a user device as described with reference to FIGS. 1 through 13. In some examples, a user device may execute a set of instructions to control the functional elements of the user device to perform the described functions. Additionally, or alternatively, the user device may perform aspects of the described functions using special-purpose hardware.

At 1605, the method may include displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token. The operations of 1605 may be performed in accordance with examples as disclosed herein. In some examples, aspects of the operations of 1605 may be performed by a trade page component 1225 as described with reference to FIG. 12.

At 1610, the method may include displaying, in response to receiving one or more first user inputs at the first user interface page, a second user interface page associated with exchange of a second crypto token and comprising a second set of fields associated with a second exchange order for the second crypto token and a second dynamically updated order book associated with exchange of the second crypto token. The operations of 1610 may be performed in accordance with examples as disclosed herein. In some examples, aspects of the operations of 1610 may be performed by a second trade page component 1245 as described with reference to FIG. 12.

At 1615, the method may include displaying, in response to receiving one or more second user inputs, a third user interface page comprising a list of entries for a plurality of crypto tokens including the first crypto token and the second crypto token. The operations of 1615 may be performed in accordance with examples as disclosed herein. In some examples, aspects of the operations of 1615 may be performed by a market selection page component 1250 as described with reference to FIG. 12.

At 1620, the method may include displaying, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token. The operations of 1620 may be performed in accordance with examples as disclosed herein. In some examples, aspects of the operations of 1620 may be performed by a trade page component 1225 as described with reference to FIG. 12.

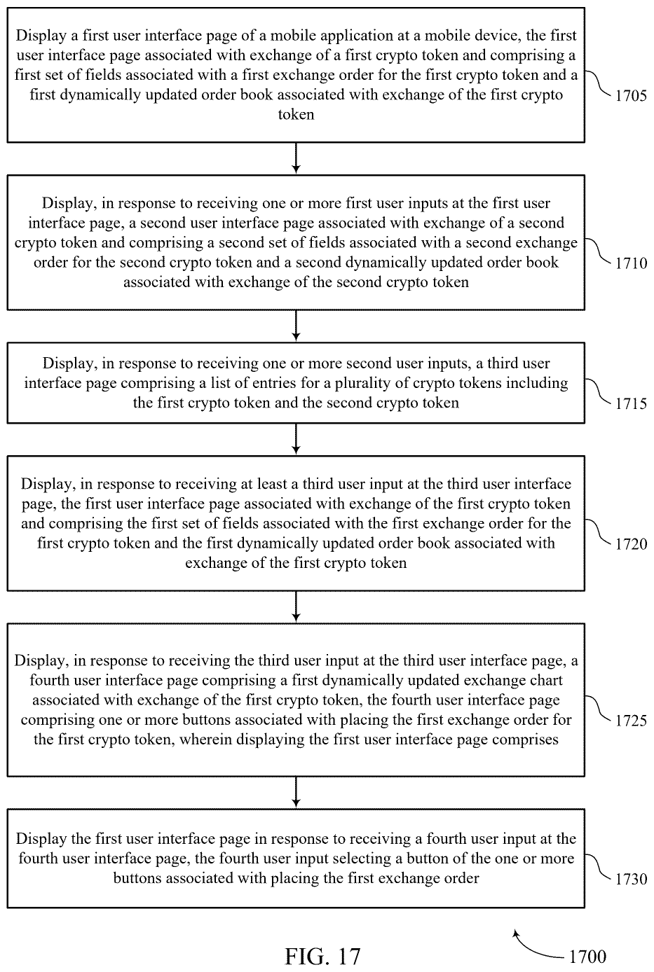

FIG. 17 shows a flowchart illustrating a method 1700 of a mobile application for a custodial token platform in accordance with aspects of the present disclosure. The operations of the method 1700 may be implemented by a user device or its components as described herein. For example, the operations of the method 1700 may be performed by a user device as described with reference to FIGS. 1 through 13. In some examples, a user device may execute a set of instructions to control the functional elements of the user device to perform the described functions. Additionally, or alternatively, the user device may perform aspects of the described functions using special-purpose hardware.

At 1705, the method may include displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token. The operations of 1705 may be performed in accordance with examples as disclosed herein. In some examples, aspects of the operations of 1705 may be performed by a trade page component 1225 as described with reference to FIG. 12.

At 1710, the method may include displaying, in response to receiving one or more first user inputs at the first user interface page, a second user interface page associated with exchange of a second crypto token and comprising a second set of fields associated with a second exchange order for the second crypto token and a second dynamically updated order book associated with exchange of the second crypto token. The operations of 1710 may be performed in accordance with examples as disclosed herein. In some examples, aspects of the operations of 1710 may be performed by a second trade page component 1245 as described with reference to FIG. 12.

At 1715, the method may include displaying, in response to receiving one or more second user inputs, a third user interface page comprising a list of entries for a plurality of crypto tokens including the first crypto token and the second crypto token. The operations of 1715 may be performed in accordance with examples as disclosed herein. In some examples, aspects of the operations of 1715 may be performed by a market selection page component 1250 as described with reference to FIG. 12.

At 1720, the method may include displaying, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token. The operations of 1720 may be performed in accordance with examples as disclosed herein. In some examples, aspects of the operations of 1720 may be performed by a trade page component 1225 as described with reference to FIG. 12.

At 1725, the method may include displaying, in response to receiving the third user input at the third user interface page, a fourth user interface page comprising a first dynamically updated exchange chart associated with exchange of the first crypto token, the fourth user interface page comprising one or more buttons associated with placing the first exchange order for the first crypto token, wherein displaying the first user interface page comprises. The operations of 1725 may be performed in accordance with examples as disclosed herein. In some examples, aspects of the operations of 1725 may be performed by an asset detail page component 1265 as described with reference to FIG. 12.

At 1730, the method may include displaying the first user interface page in response to receiving a fourth user input at the fourth user interface page, the fourth user input selecting a button of the one or more buttons associated with placing the first exchange order. The operations of 1730 may be performed in accordance with examples as disclosed herein. In some examples, aspects of the operations of 1730 may be performed by a trade page component 1225 as described with reference to FIG. 12.

A method by an apparatus is described. The method may include displaying a first user interface page of a mobile application at a mobile device, the first user interface page associated with exchange of a first crypto token and comprising a set of fields associated with an exchange order for the first crypto token and a dynamically updated order book associated with exchange of the first crypto token, displaying, in response to detecting a first user input at the first user interface page, an orders section within the first user interface page and including one or more first open exchange orders associated with the first crypto token and a user interface button associated with viewing open exchange orders for a plurality of crypto tokens, and displaying, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

An apparatus is described. The apparatus may include one or more memories storing processor executable code, and one or more processors coupled with the one or more memories. The one or more processors may individually or collectively be operable to execute the code to cause the apparatus to display a first user interface page of a mobile application at a mobile device, the first user interface page associated with exchange of a first crypto token and comprising a set of fields associated with an exchange order for the first crypto token and a dynamically updated order book associated with exchange of the first crypto token, display, in response to detecting a first user input at the first user interface page, an orders section within the first user interface page and including one or more first open exchange orders associated with the first crypto token and a user interface button associated with viewing open exchange orders for a plurality of crypto tokens, and display, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

Another apparatus is described. The apparatus may include means for displaying a first user interface page of a mobile application at a mobile device, the first user interface page associated with exchange of a first crypto token and comprising a set of fields associated with an exchange order for the first crypto token and a dynamically updated order book associated with exchange of the first crypto token, means for displaying, in response to detecting a first user input at the first user interface page, an orders section within the first user interface page and including one or more first open exchange orders associated with the first crypto token and a user interface button associated with viewing open exchange orders for a plurality of crypto tokens, and means for displaying, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

A non-transitory computer-readable medium storing code is described. The code may include instructions executable by one or more processors to display a first user interface page of a mobile application at a mobile device, the first user interface page associated with exchange of a first crypto token and comprising a set of fields associated with an exchange order for the first crypto token and a dynamically updated order book associated with exchange of the first crypto token, display, in response to detecting a first user input at the first user interface page, an orders section within the first user interface page and including one or more first open exchange orders associated with the first crypto token and a user interface button associated with viewing open exchange orders for a plurality of crypto tokens, and display, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

Some examples of the method, apparatus, and non-transitory computer-readable medium described herein may further include operations, features, means, or instructions for displaying, at the mobile application, two or more tab user interface components, a first tab user interface component associated with viewing open exchange orders for the plurality of crypto tokens, receiving a third user input selecting the first tab user interface component, and displaying, in response to receiving the third user input, the second user interface page comprising the one or more first open exchange orders and the one or more second open exchange orders.

In some examples of the method, apparatus, and non-transitory computer-readable medium described herein, the first user interface page further comprises one or more user interface buttons associated with hiding or displaying user interface components within the first user interface page.

Some examples of the method, apparatus, and non-transitory computer-readable medium described herein may further include operations, features, means, or instructions for receiving, at a first user interface button of the one or more user interface buttons, a third user input selecting the first user interface button and displaying, in response to receiving the third user input, a dynamically updated exchange chart associated with exchange of the first crypto token.

Some examples of the method, apparatus, and non-transitory computer-readable medium described herein may further include operations, features, means, or instructions for receiving, at a first user interface button of the one or more user interface buttons, a third user input selecting the first user interface button and removing, in response to receiving the third user input, display of the dynamically updated order book associated with exchange of the first crypto token.

Some examples of the method, apparatus, and non-transitory computer-readable medium described herein may further include operations, features, means, or instructions for resizing the set of fields to at least partially replace a position in the first user interface page that displayed the dynamically updated order book.

Some examples of the method, apparatus, and non-transitory computer-readable medium described herein may further include operations, features, means, or instructions for displaying, in response to receiving one or more third user inputs, the first user interface page, displaying, in response to receiving a fourth user input selecting a user interface component comprising information associated with the first crypto token, a third user interface page displaying a list of entries for the plurality of crypto tokens including the first crypto token, and displaying, in response to receiving a fifth user input selecting an entry for a second crypto token of the plurality of crypto tokens, a fourth user interface page associated with exchange of the second crypto token and comprising a second set of fields associated with a second exchange order for the second crypto token and a second dynamically updated order book associated with exchange of the second crypto token.

In some examples of the method, apparatus, and non-transitory computer-readable medium described herein, the first user interface page comprises a first dynamically updated exchange chart associated with exchange of the first crypto token and the method, apparatuses, and non-transitory computer-readable medium may include further operations, features, means, or instructions for displaying, in response to receiving one or more third user inputs, a third user interface page comprising a second dynamically updated exchange chart associated with exchange of the first crypto token, wherein the second user interface page comprises one or more user interface buttons associated with selectively displaying exchange indicators in associated with the second dynamically updated exchange chart, modifying an interval associated with the second dynamically updated exchange chart, or both, and wherein the first user interface page comprises the first dynamically updated exchange chart without the one or more user interface buttons.

Some examples of the method, apparatus, and non-transitory computer-readable medium described herein may further include operations, features, means, or instructions for receiving, at the first user interface page, a third user input selecting an order book line within the dynamically updated order book and populating a field of the set of fields associated with the exchange order with a price value corresponding to the selected order book line.

A method by an apparatus is described. The method may include one or more memories storing processor-executable code, one or more processors coupling with the one or more memories and individually or collectively operable to execute the code to cause the apparatus to, displaying a first user interface page of a mobile application at a mobile device, the first user interface page associated with exchange of a first crypto token and comprising a set of fields associated with an exchange order for the first crypto token and a dynamically updated order book associated with exchange of the first crypto token, display, in response to detecting a first user input at the first user interface page, an orders section within the first user interface page and including one or more first open exchange orders associated with the first crypto token and a user interface button associated with viewing open exchange orders for a plurality of crypto tokens, and display, in response to receiving a second user input selecting a first tab user interface component displayed by the mobile application, a second user interface page the one or more first open exchange orders associated with the first crypto token and one or more second open exchange orders associated with one or more second crypto tokens of the plurality of crypto tokens.

An apparatus is described. The apparatus may include one or more memories storing processor executable code, and one or more processors coupled with the one or more memories. The one or more processors may individually or collectively be operable to execute the code to cause the apparatus to one or more memories storing processor-executable code, one or more processors coupled with the one or more memories and individually or collectively operable to execute the code to cause the apparatus to, display a first user interface page of a mobile application at a mobile device, the first user interface page associated with exchange of a first crypto token and comprising a set of fields associated with an exchange order for the first crypto token and a dynamically updated order book associated with exchange of the first crypto token, display, in response to detecting a first user input at the first user interface page, an orders section within the first user interface page and including one or more first open exchange orders associated with the first crypto token and a user interface button associated with viewing open exchange orders for a plurality of crypto tokens, and display, in response to receiving a second user input selecting a first tab user interface component displayed by the mobile application, a second user interface page the one or more first open exchange orders associated with the first crypto token and one or more second open exchange orders associated with one or more second crypto tokens of the plurality of crypto tokens.

Another apparatus is described. The apparatus may include means for one or more memories storing processor-executable code, means for one or more processors coupling with the one or more memories and individually or collectively operable to execute the code to cause the apparatus to, means for displaying a first user interface page of a mobile application at a mobile device, the first user interface page associated with exchange of a first crypto token and comprising a set of fields associated with an exchange order for the first crypto token and a dynamically updated order book associated with exchange of the first crypto token, means for display, in response to detecting a first user input at the first user interface page, an orders section within the first user interface page and including one or more first open exchange orders associated with the first crypto token and a user interface button associated with viewing open exchange orders for a plurality of crypto tokens, and means for display, in response to receiving a second user input selecting a first tab user interface component displayed by the mobile application, a second user interface page the one or more first open exchange orders associated with the first crypto token and one or more second open exchange orders associated with one or more second crypto tokens of the plurality of crypto tokens.

A non-transitory computer-readable medium storing code is described. The code may include instructions executable by one or more processors to one or more memories storing processor-executable code, one or more processors coupled with the one or more memories and individually or collectively operable to execute the code to cause the apparatus to, display a first user interface page of a mobile application at a mobile device, the first user interface page associated with exchange of a first crypto token and comprising a set of fields associated with an exchange order for the first crypto token and a dynamically updated order book associated with exchange of the first crypto token, display, in response to detecting a first user input at the first user interface page, an orders section within the first user interface page and including one or more first open exchange orders associated with the first crypto token and a user interface button associated with viewing open exchange orders for a plurality of crypto tokens, and display, in response to receiving a second user input selecting a first tab user interface component displayed by the mobile application, a second user interface page the one or more first open exchange orders associated with the first crypto token and one or more second open exchange orders associated with one or more second crypto tokens of the plurality of crypto tokens.

A method by an apparatus is described. The method may include displaying a first user interface page of a mobile application at a mobile device, the first user interface page associated with exchange of a first crypto token and comprising a set of fields associated with an exchange order for the first crypto token, a dynamically updated order book associated with exchange of the first crypto token, and one or more user interface buttons associated with hiding or displaying user interface components within the first user interface page, display, in response to detecting a first user input at the first user interface page, an orders section within the first user interface page and including one or more first open exchange orders associated with the first crypto token and a user interface button associated with viewing open exchange orders for a plurality of crypto tokens, and display, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

An apparatus is described. The apparatus may include one or more memories storing processor executable code, and one or more processors coupled with the one or more memories. The one or more processors may individually or collectively be operable to execute the code to cause the apparatus to display a first user interface page of a mobile application at a mobile device, the first user interface page associated with exchange of a first crypto token and comprising a set of fields associated with an exchange order for the first crypto token, a dynamically updated order book associated with exchange of the first crypto token, and one or more user interface buttons associated with hiding or displaying user interface components within the first user interface page, display, in response to detecting a first user input at the first user interface page, an orders section within the first user interface page and including one or more first open exchange orders associated with the first crypto token and a user interface button associated with viewing open exchange orders for a plurality of crypto tokens, and display, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

Another apparatus is described. The apparatus may include means for displaying a first user interface page of a mobile application at a mobile device, the first user interface page associated with exchange of a first crypto token and comprising a set of fields associated with an exchange order for the first crypto token, a dynamically updated order book associated with exchange of the first crypto token, and one or more user interface buttons associated with hiding or displaying user interface components within the first user interface page, means for display, in response to detecting a first user input at the first user interface page, an orders section within the first user interface page and including one or more first open exchange orders associated with the first crypto token and a user interface button associated with viewing open exchange orders for a plurality of crypto tokens, and means for display, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

A non-transitory computer-readable medium storing code is described. The code may include instructions executable by one or more processors to display a first user interface page of a mobile application at a mobile device, the first user interface page associated with exchange of a first crypto token and comprising a set of fields associated with an exchange order for the first crypto token, a dynamically updated order book associated with exchange of the first crypto token, and one or more user interface buttons associated with hiding or displaying user interface components within the first user interface page, display, in response to detecting a first user input at the first user interface page, an orders section within the first user interface page and including one or more first open exchange orders associated with the first crypto token and a user interface button associated with viewing open exchange orders for a plurality of crypto tokens, and display, in response to receiving a second user input selecting the user interface button in the orders section, a second user interface page of the mobile application, the second user interface page comprising the one or more first open exchange orders associated with the first crypto token and one or more second open exchange orders associated with one or more second crypto tokens of the plurality of crypto tokens.

A method by an apparatus is described. The method may include displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token, displaying, in response to receiving one or more first user inputs at the first user interface page, a second user interface page associated with exchange of a second crypto token and comprising a second set of fields associated with a second exchange order for the second crypto token and a second dynamically updated order book associated with exchange of the second crypto token, displaying, in response to receiving one or more second user inputs, a third user interface page comprising a list of entries for a plurality of crypto tokens including the first crypto token and the second crypto token, and displaying, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

An apparatus is described. The apparatus may include one or more memories storing processor executable code, and one or more processors coupled with the one or more memories. The one or more processors may individually or collectively be operable to execute the code to cause the apparatus to display a first user interface page of a mobile application at a mobile device, the first user interface page associated with exchange of a first crypto token and comprising a first set of fields associated with a first exchange order for the first crypto token and a first dynamically updated order book associated with exchange of the first crypto token, display, in response to receiving one or more first user inputs at the first user interface page, a second user interface page associated with exchange of a second crypto token and comprising a second set of fields associated with a second exchange order for the second crypto token and a second dynamically updated order book associated with exchange of the second crypto token, display, in response to receiving one or more second user inputs, a third user interface page comprising a list of entries for a plurality of crypto tokens including the first crypto token and the second crypto token, and display, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

Another apparatus is described. The apparatus may include means for displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token, means for displaying, in response to receiving one or more first user inputs at the first user interface page, a second user interface page associated with exchange of a second crypto token and comprising a second set of fields associated with a second exchange order for the second crypto token and a second dynamically updated order book associated with exchange of the second crypto token, means for displaying, in response to receiving one or more second user inputs, a third user interface page comprising a list of entries for a plurality of crypto tokens including the first crypto token and the second crypto token, and means for displaying, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

A non-transitory computer-readable medium storing code is described. The code may include instructions executable by one or more processors to display a first user interface page of a mobile application at a mobile device, the first user interface page associated with exchange of a first crypto token and comprising a first set of fields associated with a first exchange order for the first crypto token and a first dynamically updated order book associated with exchange of the first crypto token, display, in response to receiving one or more first user inputs at the first user interface page, a second user interface page associated with exchange of a second crypto token and comprising a second set of fields associated with a second exchange order for the second crypto token and a second dynamically updated order book associated with exchange of the second crypto token, display, in response to receiving one or more second user inputs, a third user interface page comprising a list of entries for a plurality of crypto tokens including the first crypto token and the second crypto token, and display, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

Some examples of the method, apparatus, and non-transitory computer-readable medium described herein may further include operations, features, means, or instructions for displaying, in response to receiving the third user input at the third user interface page, a fourth user interface page comprising a first dynamically updated exchange chart associated with exchange of the first crypto token, the fourth user interface page comprising one or more buttons associated with placing the first exchange order for the first crypto token, wherein displaying the first user interface page comprises and displaying the first user interface page in response to receiving a fourth user input at the fourth user interface page, the fourth user input selecting a button of the one or more buttons associated with placing the first exchange order.

In some examples of the method, apparatus, and non-transitory computer-readable medium described herein, the fourth user interface page comprising the first dynamically updated exchange chart comprises one or more user interface buttons associated with selectively displaying exchange indicators associated with the first dynamically updated exchange chart, modifying an interval associated with the first dynamically updated exchange chart, or both and the first user interface page comprises a second dynamically updated exchange chart without the one or more user interface buttons.

In some examples of the method, apparatus, and non-transitory computer-readable medium described herein, the first user interface page further comprises one or more user interface buttons associated with hiding or displaying user interface components within the first user interface page.

Some examples of the method, apparatus, and non-transitory computer-readable medium described herein may further include operations, features, means, or instructions for receiving, at a first user interface button of the one or more user interface buttons, a fourth user input selecting the first user interface button and displaying, in response to receiving the third user input, a dynamically updated exchange chart associated with exchange of the first crypto token.

Some examples of the method, apparatus, and non-transitory computer-readable medium described herein may further include operations, features, means, or instructions for receiving, at a first user interface button of the one or more user interface buttons, a third user input selecting the first user interface button and removing, in response to receiving the third user input, display of the first dynamically updated order book associated with exchange of the first crypto token.

Some examples of the method, apparatus, and non-transitory computer-readable medium described herein may further include operations, features, means, or instructions for resizing the second set of fields to at least partially replace a position in the first user interface page that displayed the first dynamically updated order book.

Some examples of the method, apparatus, and non-transitory computer-readable medium described herein may further include operations, features, means, or instructions for displaying, in response to receiving a fourth user input at the first user interface page, an orders section within the first user interface page and including one or more first open exchange orders associated with the first crypto token and a user interface button associated with viewing open exchange orders for the plurality of crypto tokens and displaying, in response to receiving a fifth user input selecting the user interface button in the orders section, a third user interface page of the mobile application, the third user interface page comprising the one or more first open exchange orders associated with the first crypto token and one or more second open exchange orders associated with the second crypto token of the plurality of crypto tokens.

Some examples of the method, apparatus, and non-transitory computer-readable medium described herein may further include operations, features, means, or instructions for displaying, at the mobile application, two or more tab user interface components, a first tab user interface component associated with viewing open exchange orders for the plurality of crypto tokens, receiving a sixth user input selecting the first tab user interface component, and displaying, in response to receiving the sixth user input selecting the first tab user interface component, the third user interface page comprising the one or more first open exchange orders associated with the first crypto token and the one or more second open exchange orders associated with the second crypto token of the plurality of crypto tokens.

A method by an apparatus is described. The method may include one or more memories storing processor-executable code, one or more processors coupling with the one or more memories and individually or collectively operable to execute the code to cause the apparatus to, displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token, display, in response to receiving at least a first user inputs at the first user interface page, a second user interface page associated with exchange of a second crypto token and comprising a second set of fields associated with a second exchange order for the second crypto token and a second dynamically updated order book associated with exchange of the first crypto token, display, in response to receiving one or more second user inputs, a third user interface page comprising a list of entries for a plurality of crypto tokens including the first crypto token and the second crypto token, displaying, in response to receiving a third user input at the third user interface page, a fourth user interface page comprising a first dynamically updated exchange chart associated with exchange of the second crypto token, the fourth user interface page comprising one or more buttons associated with placing the second exchange order for the second crypto token, and display, in response to receiving at least a fourth user input at the fourth user interface page, the first user interface page associated with exchange of the first crypto token and comprising the first set of fields associated with the first exchange order for the first crypto token and the first dynamically updated order book associated with exchange of the first crypto token.

An apparatus is described. The apparatus may include one or more memories storing processor executable code, and one or more processors coupled with the one or more memories. The one or more processors may individually or collectively be operable to execute the code to cause the apparatus to one or more memories storing processor-executable code, one or more processors coupled with the one or more memories and individually or collectively operable to execute the code to cause the apparatus to, display a first user interface page of a mobile application at a mobile device, the first user interface page associated with exchange of a first crypto token and comprising a first set of fields associated with a first exchange order for the first crypto token and a first dynamically updated order book associated with exchange of the first crypto token, display, in response to receiving at least a first user inputs at the first user interface page, a second user interface page associated with exchange of a second crypto token and comprising a second set of fields associated with a second exchange order for the second crypto token and a second dynamically updated order book associated with exchange of the first crypto token, display, in response to receiving one or more second user inputs, a third user interface page comprising a list of entries for a plurality of crypto tokens including the first crypto token and the second crypto token, displaying, in response to receiving a third user input at the third user interface page, a fourth user interface page comprising a first dynamically updated exchange chart associated with exchange of the second crypto token, the fourth user interface page comprising one or more buttons associated with placing the second exchange order for the second crypto token, and display, in response to receiving at least a fourth user input at the fourth user interface page, the first user interface page associated with exchange of the first crypto token and comprising the first set of fields associated with the first exchange order for the first crypto token and the first dynamically updated order book associated with exchange of the first crypto token.

Another apparatus is described. The apparatus may include means for one or more memories storing processor-executable code, means for one or more processors coupling with the one or more memories and individually or collectively operable to execute the code to cause the apparatus to, means for displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token, means for display, in response to receiving at least a first user inputs at the first user interface page, a second user interface page associated with exchange of a second crypto token and comprising a second set of fields associated with a second exchange order for the second crypto token and a second dynamically updated order book associated with exchange of the first crypto token, means for display, in response to receiving one or more second user inputs, a third user interface page comprising a list of entries for a plurality of crypto tokens including the first crypto token and the second crypto token, means for displaying, in response to receiving a third user input at the third user interface page, a fourth user interface page comprising a first dynamically updated exchange chart associated with exchange of the second crypto token, the fourth user interface page comprising one or more buttons associated with placing the second exchange order for the second crypto token, and means for display, in response to receiving at least a fourth user input at the fourth user interface page, the first user interface page associated with exchange of the first crypto token and comprising the first set of fields associated with the first exchange order for the first crypto token and the first dynamically updated order book associated with exchange of the first crypto token.

A non-transitory computer-readable medium storing code is described. The code may include instructions executable by one or more processors to one or more memories storing processor-executable code, one or more processors coupled with the one or more memories and individually or collectively operable to execute the code to cause the apparatus to, display a first user interface page of a mobile application at a mobile device, the first user interface page associated with exchange of a first crypto token and comprising a first set of fields associated with a first exchange order for the first crypto token and a first dynamically updated order book associated with exchange of the first crypto token, display, in response to receiving at least a first user inputs at the first user interface page, a second user interface page associated with exchange of a second crypto token and comprising a second set of fields associated with a second exchange order for the second crypto token and a second dynamically updated order book associated with exchange of the first crypto token, display, in response to receiving one or more second user inputs, a third user interface page comprising a list of entries for a plurality of crypto tokens including the first crypto token and the second crypto token, displaying, in response to receiving a third user input at the third user interface page, a fourth user interface page comprising a first dynamically updated exchange chart associated with exchange of the second crypto token, the fourth user interface page comprising one or more buttons associated with placing the second exchange order for the second crypto token, and display, in response to receiving at least a fourth user input at the fourth user interface page, the first user interface page associated with exchange of the first crypto token and comprising the first set of fields associated with the first exchange order for the first crypto token and the first dynamically updated order book associated with exchange of the first crypto token.

A method by an apparatus is described. The method may include displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token, display, in response to receiving at least a first user inputs at the first user interface page, a second user interface page associated with exchange of a second crypto token and comprising a second set of fields associated with a second exchange order for the second crypto token, a second dynamically updated order book associated with exchange of the first crypto token, and one or more user interface buttons associated with hiding or displaying user interface components within the second user interface page, display, in response to receiving one or more second user inputs, a third user interface page comprising a list of entries for a plurality of crypto tokens including the first crypto token and the second crypto token, and display, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

An apparatus is described. The apparatus may include one or more memories storing processor executable code, and one or more processors coupled with the one or more memories. The one or more processors may individually or collectively be operable to execute the code to cause the apparatus to display a first user interface page of a mobile application at a mobile device, the first user interface page associated with exchange of a first crypto token and comprising a first set of fields associated with a first exchange order for the first crypto token and a first dynamically updated order book associated with exchange of the first crypto token, display, in response to receiving at least a first user inputs at the first user interface page, a second user interface page associated with exchange of a second crypto token and comprising a second set of fields associated with a second exchange order for the second crypto token, a second dynamically updated order book associated with exchange of the first crypto token, and one or more user interface buttons associated with hiding or displaying user interface components within the second user interface page, display, in response to receiving one or more second user inputs, a third user interface page comprising a list of entries for a plurality of crypto tokens including the first crypto token and the second crypto token, and display, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

Another apparatus is described. The apparatus may include means for displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token, means for display, in response to receiving at least a first user inputs at the first user interface page, a second user interface page associated with exchange of a second crypto token and comprising a second set of fields associated with a second exchange order for the second crypto token, a second dynamically updated order book associated with exchange of the first crypto token, and one or more user interface buttons associated with hiding or displaying user interface components within the second user interface page, means for display, in response to receiving one or more second user inputs, a third user interface page comprising a list of entries for a plurality of crypto tokens including the first crypto token and the second crypto token, and means for display, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

A non-transitory computer-readable medium storing code is described. The code may include instructions executable by one or more processors to display a first user interface page of a mobile application at a mobile device, the first user interface page associated with exchange of a first crypto token and comprising a first set of fields associated with a first exchange order for the first crypto token and a first dynamically updated order book associated with exchange of the first crypto token, display, in response to receiving at least a first user inputs at the first user interface page, a second user interface page associated with exchange of a second crypto token and comprising a second set of fields associated with a second exchange order for the second crypto token, a second dynamically updated order book associated with exchange of the first crypto token, and one or more user interface buttons associated with hiding or displaying user interface components within the second user interface page, display, in response to receiving one or more second user inputs, a third user interface page comprising a list of entries for a plurality of crypto tokens including the first crypto token and the second crypto token, and display, in response to receiving at least a third user input at the third user interface page, the first user interface page associated with exchange of the first crypto token and comprising the first set of fields associated with the first exchange order for the first crypto token and the first dynamically updated order book associated with exchange of the first crypto token.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
displaying a first user interface page of a mobile application at a mobile device, the first user interface page associated with exchange of a first crypto token and comprising a first set of fields associated with a first exchange order for the first crypto token and a first dynamically updated order book associated with exchange of the first crypto token;
displaying, in response to receiving at least a first user input at the first user interface page, a second user interface page associated with exchange of a second crypto token and comprising a second set of fields associated with a second exchange order for the second crypto token and a second dynamically updated order book associated with exchange of the first crypto token;
displaying, in response to receiving one or more second user inputs, a third user interface page comprising a list of entries for a plurality of crypto tokens including the first crypto token and the second crypto token; and
displaying, in response to receiving at least a third user input at the third user interface page, the second user interface page associated with exchange of the second crypto token and comprising the second set of fields associated with the second exchange order for the second crypto token and the second dynamically updated order book associated with exchange of the first crypto token.

2. The method of claim 1, further comprising:
displaying, in response to receiving the third user input at the third user interface page, a fourth user interface page comprising a first dynamically updated exchange chart associated with exchange of the second crypto token, the fourth user interface page comprising one or more buttons associated with placing the second exchange order for the second crypto token, wherein displaying the second user interface page comprises:
displaying the second user interface page in response to receiving a fourth user input at the fourth user interface page, the fourth user input selecting a button of the one or more buttons associated with placing the second exchange order.

3. The method of claim 2, wherein:
the fourth user interface page comprising the first dynamically updated exchange chart comprises one or more user interface buttons associated with selectively displaying exchange indicators in associated with the first dynamically updated exchange chart, modifying an interval associated with the first dynamically updated exchange chart, or both, and
the second user interface page comprises a second dynamically updated exchange chart without the one or more user interface buttons.

4. The method of claim 1, wherein the second user interface page further comprises one or more user interface buttons associated with hiding or displaying the user interface components within the second user interface page.

5. The method of claim 4, further comprising:
receiving, at a first user interface button of the one or more user interface buttons, a fourth user input selecting the first user interface button; and
displaying, in response to receiving the third user input, a dynamically updated exchange chart associated with exchange of the second crypto token.

6. The method of claim 4, further comprising:
receiving, at a first user interface button of the one or more user interface buttons, a third user input selecting the first user interface button; and
removing, in response to receiving the third user input, display of the second dynamically updated order book associated with exchange of the second crypto token.

7. The method of claim 1, further comprising:
resizing the second set of fields to at least partially replace a position in the second interface page that displayed the second dynamically updated order book.

8. The method of claim 1, further comprising:
displaying, in response to receiving a fourth user input at the first user interface page, an orders section within the first user interface page and including one or more first open exchange orders associated with the second crypto token and a user interface button associated with viewing open exchange orders for the plurality of crypto tokens; and
displaying, in response to receiving a fifth user input selecting the user interface button in the orders section, a third user interface page of the mobile application, the third user interface page comprising the one or more first open exchange orders associated with the second crypto token and one or more second open exchange orders associated with the first crypto token of the plurality of crypto tokens.

9. The method of claim 8, further comprising:
displaying, at the mobile application, two or more tab user interface components, a first tab user interface component associated with viewing open exchange orders for the plurality of crypto tokens;
receiving a sixth user input selecting the first tab user interface component; and
displaying, in response to receiving the sixth user input selecting the first tab user interface component, the third user interface page comprising the one or more first open exchange orders associated with the second crypto token and the one or more second open exchange orders associated with the first crypto token of the plurality of crypto tokens.

10. An apparatus, comprising:
one or more memories storing processor-executable code; and
one or more processors coupled with the one or more memories and individually or collectively operable to execute the code to cause the apparatus to:
display a first user interface page of a mobile application at a mobile device, the first user interface page associated with exchange of a first crypto token and comprising a first set of fields associated with a first exchange order for the first crypto token and a first dynamically updated order book associated with exchange of the first crypto token;
display, in response to receiving at least a first user inputs at the first user interface page, a second user interface page associated with exchange of a second crypto token and comprising a second set of fields associated with a second exchange order for the second crypto token and a second dynamically updated order book associated with exchange of the first crypto token;
display, in response to receiving one or more second user inputs, a third user interface page comprising a list of entries for a plurality of crypto tokens including the first crypto token and the second crypto token;
displaying, in response to receiving a third user input at the third user interface page, a fourth user interface page comprising a first dynamically updated exchange chart associated with exchange of the second crypto token, the fourth user interface page comprising one or more buttons associated with placing the second exchange order for the second crypto token; and
display, in response to receiving at least a fourth user input at the fourth user interface page, the second user interface page associated with exchange of the second crypto token and comprising the second set of fields associated with the second exchange order for the second crypto token and the second dynamically updated order book associated with exchange of the first crypto token.

11. The apparatus of claim 10, wherein the second user interface page further comprises one or more user interface buttons associated with hiding or displaying user interface components within the second user interface page.

12. The apparatus of claim 11, wherein the one or more processors are individually or collectively further operable to execute the code to cause the apparatus to:
receive, at a first user interface button of the one or more user interface buttons, a fourth user input selecting the first user interface button; and
display, in response to receiving the third user input, a dynamically updated exchange chart associated with exchange of the second crypto token.

13. The apparatus of claim 11, wherein the one or more processors are individually or collectively further operable to execute the code to cause the apparatus to:
receive, at a first user interface button of the one or more user interface buttons, a third user input selecting the first user interface button; and
remove, in response to receiving the third user input, display of the second dynamically updated order book associated with exchange of the second crypto token.

14. The apparatus of claim 10, wherein the one or more processors are individually or collectively further operable to execute the code to cause the apparatus to:
resize the second set of fields to at least partially replace a position in the second interface page that displayed the second dynamically updated order book.

15. The apparatus of claim 10, wherein the one or more processors are individually or collectively further operable to execute the code to cause the apparatus to:
display, in response to receiving a fourth user input at the first user interface page, an orders section within the first user interface page and including one or more first open exchange orders associated with the second crypto token and a user interface button associated with viewing open exchange orders for the plurality of crypto tokens; and
display, in response to receiving a fifth user input selecting the user interface button in the orders section, a third user interface page of the mobile application, the third user interface page comprising the one or more first open exchange orders associated with the second crypto token and one or more second open exchange orders associated with the first crypto token of the plurality of crypto tokens.

16. The apparatus of claim 15, wherein the one or more processors are individually or collectively further operable to execute the code to cause the apparatus to:
display, at the mobile application, two or more tab user interface components, a first tab user interface component associated with viewing open exchange orders for the plurality of crypto tokens;
receive a sixth user input selecting the first tab user interface component; and
display, in response to receiving the sixth user input selecting the first tab user interface component, the third user interface page comprising the one or more first open exchange orders associated with the second crypto token and the one or more second open exchange orders associated with the first crypto token of the plurality of crypto tokens.

17. A non-transitory computer-readable medium storing code, the code comprising instructions executable by one or more processors to:
display a first user interface page of a mobile application at a mobile device, the first user interface page associated with exchange of a first crypto token and comprising a first set of fields associated with a first exchange order for the first crypto token and a first dynamically updated order book associated with exchange of the first crypto token;
display, in response to receiving at least a first user input at the first user interface page, a second user interface page associated with exchange of a second crypto token and comprising a second set of fields associated with a second exchange order for the second crypto token, a second dynamically updated order book associated with exchange of the first crypto token, and one or more user interface buttons associated with hiding or displaying user interface components within the second user interface page;
display, in response to receiving one or more second user inputs, a third user interface page comprising a list of entries for a plurality of crypto tokens including the first crypto token and the second crypto token; and
display, in response to receiving at least a third user input at the third user interface page, the second user interface page associated with exchange of the second crypto token and comprising the second set of fields associated with the second exchange order for the second crypto token and the second dynamically updated order book associated with exchange of the first crypto token.

18. The non-transitory computer-readable medium of claim 17, wherein the instructions are further executable by the one or more processors to:
display, in response to receiving the third user input at the third user interface page, a fourth user interface page comprising a first dynamically updated exchange chart associated with exchange of the second crypto token, the fourth user interface page comprising one or more buttons associated with placing the second exchange order for the second crypto token, wherein displaying the second user interface page comprises:
displaying the second user interface page in response to receiving a fourth user input at the fourth user interface page, the fourth user input selecting a button of the one or more buttons associated with placing the second exchange order.

19. The non-transitory computer-readable medium of claim 18, wherein:
the fourth user interface page comprising the first dynamically updated exchange chart comprises one or more user interface buttons associated with selectively displaying exchange indicators associated with the first dynamically updated exchange chart, modifying an interval associated with the first dynamically updated exchange chart, or both, and
the second user interface page comprises a second dynamically updated exchange chart without the one or more user interface buttons.

20. The non-transitory computer-readable medium of claim 17, wherein the instructions are further executable by the one or more processors to:
receive, at a first user interface button of the one or more user interface buttons, a fourth user input selecting the first user interface button; and
display, in response to receiving the third user input, a dynamically updated exchange chart associated with exchange of the second crypto token.
